(19) United States
(12) Patent Application Publication
(10) Pub. No.: US 2012/0194572 A1
(43) Pub. Date: Aug. 2, 2012

(54) DISPLAY DEVICE

(75) Inventors: Kohji Saitoh, Osaka-shi (JP); Tomoko Nangou, Osaka-shi (JP)

(73) Assignee: Sharp Kabushiki Kaisha, Osaka-shi, Osaka (JP)

(21) Appl. No.: 13/392,446

(22) PCT Filed: Apr. 23, 2010
(86) PCT No.: PCT/JP2010/057270

§ 371 Date: Feb. 24, 2012

(30) Foreign Application Priority Data
Aug. 27, 2009 (JP) 2009-197286

(51) Int. Cl. G09G 5/10

(52) U.S. Cl. 345/690

(57) ABSTRACT

The present invention is a display apparatus (100) including: a display panel (1) including pixels (10) disposed in a deltaic pattern; and a gate driver (2) and a source driver (3) for driving the pixels (10), the pixels (10) being divided into a first pixel group, a second pixel group, and a third pixel group which are disposed in different positions, the gate driver (2) and the source driver (3): (i) using, to drive the first pixel group, a gamma curve C1 indicating a gamma characteristic γ1; (ii) using, to drive the second pixel group, a gamma curve C2 indicating a gamma characteristic γ2 which is different from the gamma characteristic γ1; and (iii) using, to drive the third pixel group, a gamma curve C3 indicating a gamma characteristic γ3 which is different from the gamma characteristics γ1 and γ2. This makes it possible to increase a viewing angle.

### REFERENCE TO RELATED APPLICATIONS

This application is the national stage under 35 USC 371 of International Application No. PCT/JP2010/057270, filed Apr. 23, 2010, which claims priority from Japanese Patent Application No. 2009-197286, filed Aug. 27, 2009, the entire contents of which are incorporated herein by reference.

### FIELD OF THE INVENTION

The present invention relates to a display apparatus including a display panel which has a plurality of pixels arranged in a deltaic pattern.

### BACKGROUND OF THE INVENTION

For a display panel which constitutes a liquid crystal display apparatus or the like, sought after is a technique for allowing the display panel to have an improved visibility when viewed obliquely (oblique view state), in order that a viewing angle is increased.

Patent Literature 1 discloses a liquid crystal display apparatus having (i) a liquid crystal panel which has many pixels containing a first pixel group and a second pixel group, and (ii) a data driving section which supplies gradation voltages respectively to the first and second pixel groups which gradation voltages are respectively a first data signal and a second data signal which correspond respectively to different gamma constants.

### CITATION LIST

Patent Literature 1

Japanese Patent Application Publication, Tokukai, No. 2005-352483 A (Publication Date: Dec. 22, 2005)

### SUMMARY OF INVENTION

The following describes an example of how the pixels are driven by the technique of Patent Literature 1.

FIG. 21 is a graph showing a relationship between a gradation and a relative luminance, for a case where the pixels are driven by the conventional technique. According to the example shown in FIG. 21, the first pixel group and the second pixel group are driven in accordance with gamma curves F1 and F2 which respectively indicate different gamma characteristics y and γ2′, respectively. Those relative luminances of the gamma curve F1 which correspond to gradations are higher than those of the gamma curve F4 based on a standard gamma constant. Those relative luminances of the gamma curve F2 which correspond to gradations are lower than those of the gamma curve F4.

A display apparatus to be provided in a digital camera or the like has a display panel in which pixels are disposed in a deltaic pattern. This makes it possible to display a smooth video image which becomes a stepped video image when displayed by a display panel having pixels disposed in a stripe pattern. This makes it possible to display good video images. However, in a case where such a display panel is driven by the conventional technique above, it becomes difficult to make gamma characteristics of pixels compensate each other. This leads to a problem in that an effect of increasing a viewing angle is reduced.

FIG. 22 is a view illustrating a display panel 200 in which pixels 210 disposed in a deltaic pattern are driven. In the example illustrated in FIG. 22, any two horizontally-adjacent (adjacent in a row direction) pixels 210 are alternately driven by using the gamma characteristics γ1′ and γ2′ shown in FIG. 21, respectively. However, this technique causes vertically-adjacent (adjacent in a line direction) pixels 210 which cannot be alternately driven according to different gamma constants. It follows that a serrated bright vertical line A1 (hereinafter, also referred to as “bright line”) and a serrated dark vertical line A2 (hereinafter, also referred to as “dark line”) are displayed as shown in FIG. 22. Furthermore, deteriorated is such an effect that the gamma characteristics of the pixels 210 compensate each other along the vertical direction, so that the effect of increasing a viewing angle is deteriorated.

The present invention was made in view of the problems of the conventional techniques. An object of the present invention is to provide a display apparatus which includes a display panel having pixels disposed in a deltaic pattern and which has a wide viewing angle.

In order to attain the object, a display apparatus of the present invention includes: a display panel including a plurality of pixels disposed in a deltaic pattern; and a drive circuit for driving the plurality of pixels, the plurality of pixels being divided into a first pixel group, a second pixel group, and a third pixel group which are disposed in respective different positions, said drive circuit driving the first pixel group by using a first gamma curve which indicates a first gamma characteristic, said drive circuit driving the second pixel group by using a second gamma curve which indicates a second gamma characteristic which is different from the first gamma characteristic, and said drive circuit driving the third pixel group by using a third gamma curve which indicates a third gamma characteristic which is different from each of the first gamma characteristic and the second gamma characteristic.

According to the arrangement, the plurality of pixels are disposed in the deltaic pattern. This makes it possible to display a smooth video image. Further, according to the arrangement, the three gamma curves which indicate respective three different gamma characteristics are used to drive the three pixel groups which are disposed in different positions, respectively. This allows respective gamma characteristics of the pixel groups to compensate each other, so that the visibility in the oblique view state is improved. This makes it possible to increase a viewing angle.

As described above, a display apparatus of the present invention includes: a display panel including a plurality of pixels disposed in a deltaic pattern; and a drive circuit for driving the plurality of pixels, the plurality of pixels being divided into a first pixel group, a second pixel group, and a third pixel group which are disposed in respective different positions, said drive circuit driving the first pixel group by using a first gamma curve which indicates a first gamma characteristic, said drive circuit driving the second pixel group by using a second gamma curve which indicates a second gamma characteristic which is different from the first gamma characteristic, and said drive circuit driving the third pixel group by using a third gamma curve which indicates a third gamma characteristic which is different from each of the first gamma characteristic and the second gamma characteristic. This makes it possible to increase a viewing angle.

For a fuller understanding of the nature and advantages of the invention, reference should be made to the ensuing detailed description taken in conjunction with the accompanying drawings.

### BRIEF DESCRIPTION OF DRAWINGS

FIG. 1 is a view schematically illustrating a display apparatus of one embodiment of the present invention.

FIG. 2 is a graph showing one example of gamma curves to be used by a drive circuit of the one embodiment of the present invention.

FIG. 3 is a graph showing another example of the gamma curves to be used by the drive circuit of the one embodiment of the present invention.

FIG. 4 is a graph showing another example of the gamma curves to be used by the drive circuit of the one embodiment of the present invention.

FIG. 5 is a graph showing another example of the gamma curves to be used by the drive circuit of the one embodiment of the present invention.

FIG. 6 is a graph showing another example of the gamma curves to be used by the drive circuit of the one embodiment of the present invention.

FIG. 7 is a view illustrating one example of a disposition of pixel groups in the one embodiment of the present invention.

FIG. 8 is a view illustrating another example of a disposition of the pixel groups in the one embodiment of the present invention.

FIG. 9 is a view illustrating another example of a disposition of the pixel groups in the one embodiment of the present invention.

FIG. 10 is a view illustrating another example of a disposition of the pixel groups in the one embodiment of the present invention.

FIG. 11 is a view illustrating one example of a distribution pattern of the pixel groups in the one embodiment of the present invention.

FIG. 12 is a view illustrating another example of a distribution pattern of the pixel groups in the one embodiment of the present invention.

FIG. 13 is a view illustrating another example of a distribution pattern of the pixel groups in the one embodiment of the present invention.

FIG. 14

(a) through (c) of FIG. 14 are views illustrating one example of how the dispositions of the pixel groups are switched frame by frame in the one embodiment of the present invention. (a) of FIG. 14 is a view illustrating dispositions of the pixel groups in the frame Fn. (b) of FIG. 14 is a view illustrating dispositions of the pixel groups in the frame Fn+1. (c) of FIG. 14 is a view illustrating dispositions of the pixel groups in the frame Fn+2.

FIG. 15

(a) through (c) of FIG. 15 are views illustrating another example of how the dispositions of the pixel groups are switched frame by frame in the one embodiment of the present invention. (a) of FIG. 15 is a view illustrating dispositions of the pixel groups in the frame Fn. (b) of FIG. 15 is a view illustrating dispositions of the pixel groups in the frame Fn+1. (c) of FIG. 15 is a view illustrating dispositions of the pixel groups in the frame Fn+2.

FIG. 16

(a) through (c) of FIG. 16 are views illustrating another example of how the dispositions of the pixel groups are switched frame by frame in the one embodiment of the present invention. (a) of FIG. 16 is a view illustrating dispositions of the pixel groups in the frame Fn. (b) of FIG. 16 is a view illustrating dispositions of the pixel groups in the frame Fn+1. (c) of FIG. 16 is a view illustrating dispositions of the pixel groups in the frame Fn+2.

FIG. 17

(a) through (c) of FIG. 17 are views illustrating another example of how the dispositions of the pixel groups are switched frame by frame in the one embodiment of the present invention. (a) of FIG. 17 is a view illustrating dispositions of the pixel groups in the frame Fn. (b) of FIG. 17 is a view illustrating dispositions of the pixel groups in the frame Fn+1. (c) of FIG. 17 is a view illustrating dispositions of the pixel groups in the frame Fn+2.

FIG. 18

(a) through (c) of FIG. 18 are views illustrating another example of how the dispositions of the pixel groups are switched frame by frame in the one embodiment of the present invention. (a) of FIG. 18 is a view illustrating dispositions of the pixel groups in the frame Fn. (b) of FIG. 18 is a view illustrating dispositions of the pixel groups in the frame Fn+1. (c) of FIG. 18 is a view illustrating dispositions of the pixel groups in the frame Fn+2.

FIG. 19

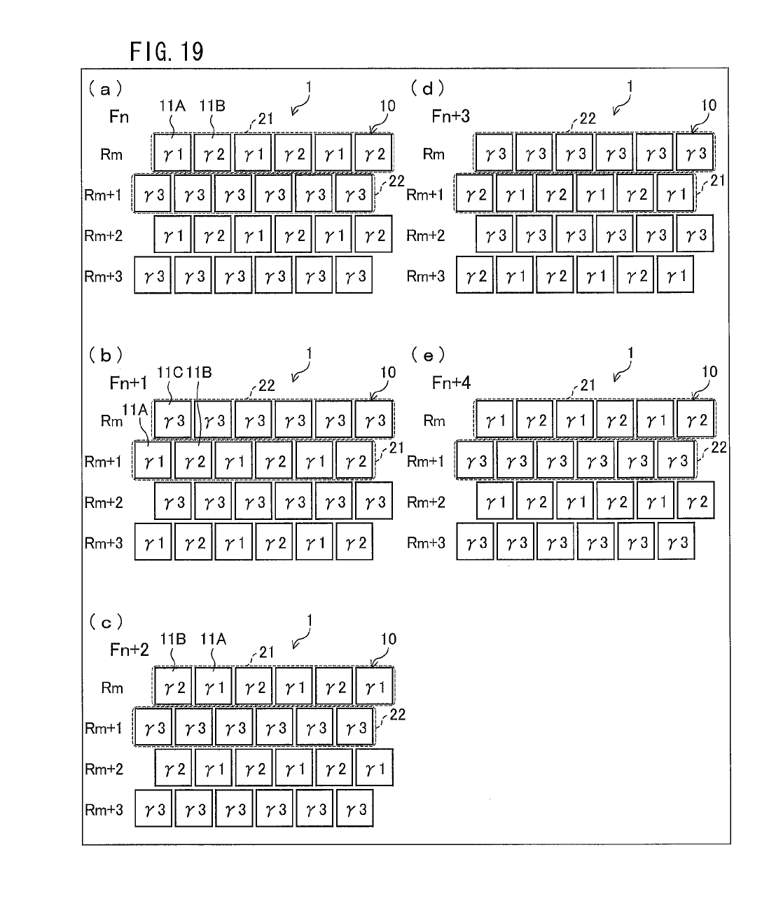

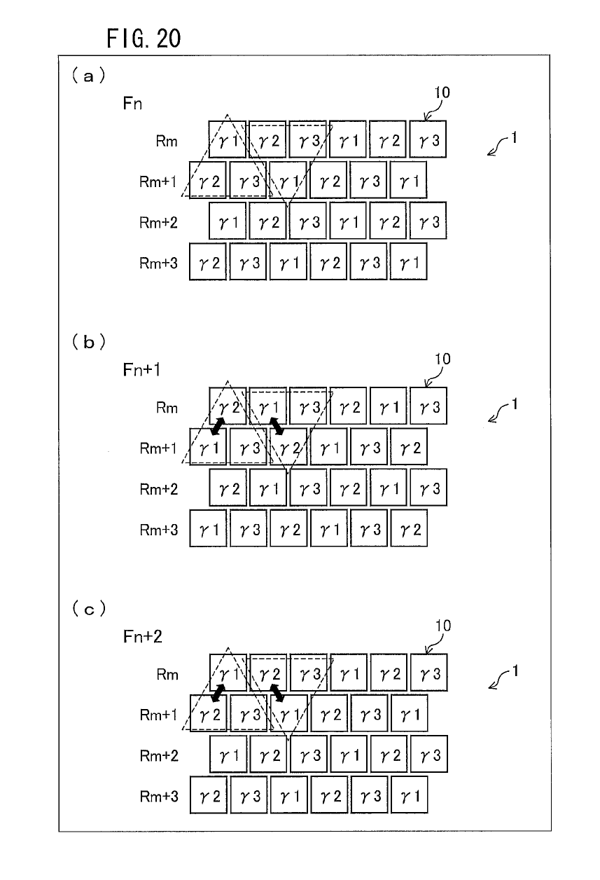

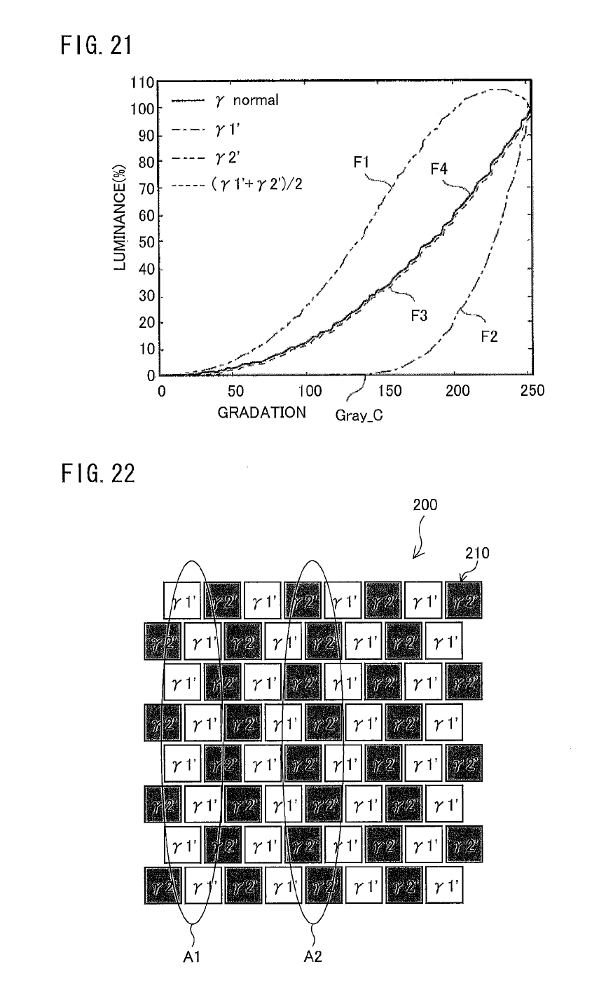

(a) through (e) of FIG. 19 are views illustrating another example of how the dispositions of the pixel groups are switched frame by frame in the one embodiment of the present invention. (a) of FIG. 19 is a view illustrating dispositions of the pixel groups in the frame Fn. (b) of FIG. 19 is a view illustrating dispositions of the pixel groups in the frame Fn+1. (c) of FIG. 19 is a view illustrating dispositions of the pixel groups in the frame Fn+2. (d) of FIG. 19 is a view illustrating dispositions of the pixel groups in the frame Fn+3. (e) of FIG. 19 is a view illustrating dispositions of the pixel groups in the frame Fn+4.

FIG. 20

(a) through (c) of FIG. 20 are views illustrating another example of how the dispositions of the pixel groups are switched frame by frame in the one embodiment of the present invention. (a) of FIG. 20 is a view illustrating dispositions of the pixel groups in the frame Fn. (b) of FIG. 20 is a view illustrating dispositions of the pixel groups in the frame Fn+1. (c) of FIG. 20 is a view illustrating dispositions of the pixel groups in the frame Fn+2.

FIG. 21 is a graph showing a relationship between a gradation and a relative luminance, for a case where the pixels are driven by a conventional technique.

FIG. 22 is a view illustrating a display panel in which pixels disposed in a deltaic pattern are driven by the conventional technique.

### DETAILED DESCRIPTION OF THE INVENTION

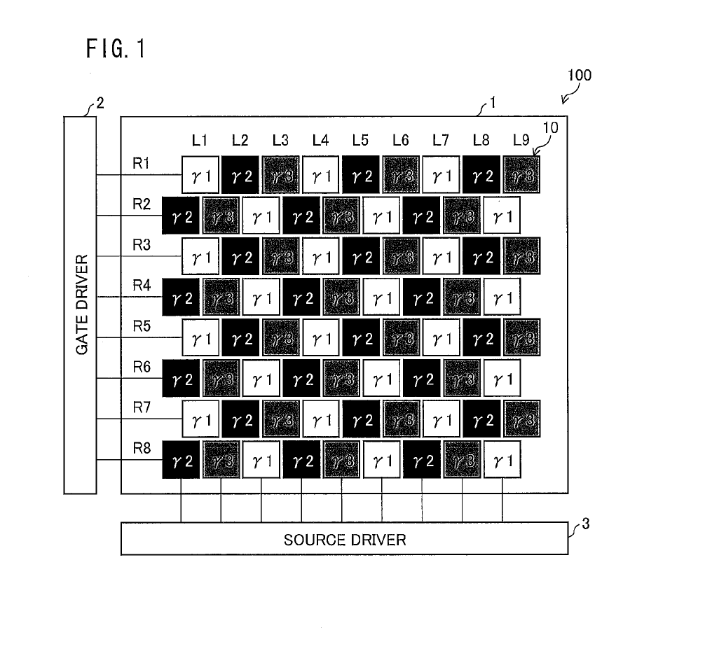

The following describes one embodiment of the present invention in detail. FIG. 1 is a view schematically illustrating a display apparatus of one embodiment of the present invention. A display apparatus 100 of the present embodiment includes a display panel 1, a gate driver 2 (drive circuit), and a source driver 3 (drive circuit).

The display panel 1 includes a plurality of pixels 10 arranged in a deltaic pattern. That is, the plurality of pixels 10 are arranged so as to be displaced by ½ pitch between those two adjacent rows of pixels 10 which correspond to two adjacent scanning lines. This makes it possible to display a smooth video image. For an easier understanding, FIG. 1 illustrates pixels 10 which are arranged in pixel lines L1 through L9 and in pixel rows R1 through R8.

A density at which the plurality of pixels 10 are provided in the display panel 1, that is, a resolution is preferably not less than 140 ppi. Further, the display panel 1 preferably includes 230,000 pixels 10, or more preferably, includes 460,000 pixels 10. The arrangement makes it possible to alleviate decrease in visual resolution (hereinafter, the decrease is also referred to as “deterioration in resolution feeling”), and allows gamma characteristics of the plurality of pixels 10 to effectively compensate each other. This makes it possible to increase a viewing angle.

The plurality of pixels 10 are divided into a first pixel group, a second pixel group, and a third pixel group which are disposed in respective different positions. In the drawings, γ1 indicates pixels 10 which constitute the first pixel group; γ2 indicates pixels 10 which constitute the second pixel group; and γ3 indicates pixels 10 which constitute the third pixel group. Where, the pixel groups are disposed is described later.

The gate driver 2 and the source driver 3 are circuits for driving the plurality of pixels 10. The gate driver 2 supplies, to the scanning lines, signals for determining a timing when each of the plurality of pixels 10 is driven. The source driver 3 converts gradations (input gradations) of video data that the source driver 3 has received, into voltages which indicate relative luminances that the plurality of pixels 10 output, and supplies the voltages thereto. The source driver 3 converts the gradations into the voltages so that relationships between the gradations and the relative luminances satisfy gamma curves which correspond respectively to the plurality of pixels 10. That is, the source driver 3 drives the plurality of pixels 10 in accordance with the gamma curves.

In order to drive the first pixel group, the source driver 3 uses a gamma curve C1 (first gamma curve) which indicates a gamma characteristic γ1 (first gamma characteristic); in order to drive the second pixel group, the source driver 3 uses a gamma curve C2 (second gamma curve) which indicates a gamma characteristic γ2 (second gamma characteristic); and in order to drive the third pixel group, the source driver 3 uses a gamma curve C3 (third gamma curve) which indicates a gamma characteristic γ3 (third gamma characteristic). That is, the three types of gamma characteristics γ1, γ2, and γ3 are assigned to the three pixel groups, respectively, in order that the three pixel groups are driven.

The gamma characteristic γ2 is different from the gamma characteristic γ1. The gamma characteristic γ3 is different from each of the gamma characteristics γ1 and γ2.

With the arrangement above, the three gamma curves C1, C2, and C3 which indicate the three different gamma characteristics γ1, γ2, and γ3 are used to drive the three pixel groups which are disposed in different positions. Accordingly, respective gamma characteristics of the three pixel groups compensate each other. This makes it possible to improve visibility of the display panel 1 in the oblique view state. As a result, a viewing angle can be increased.

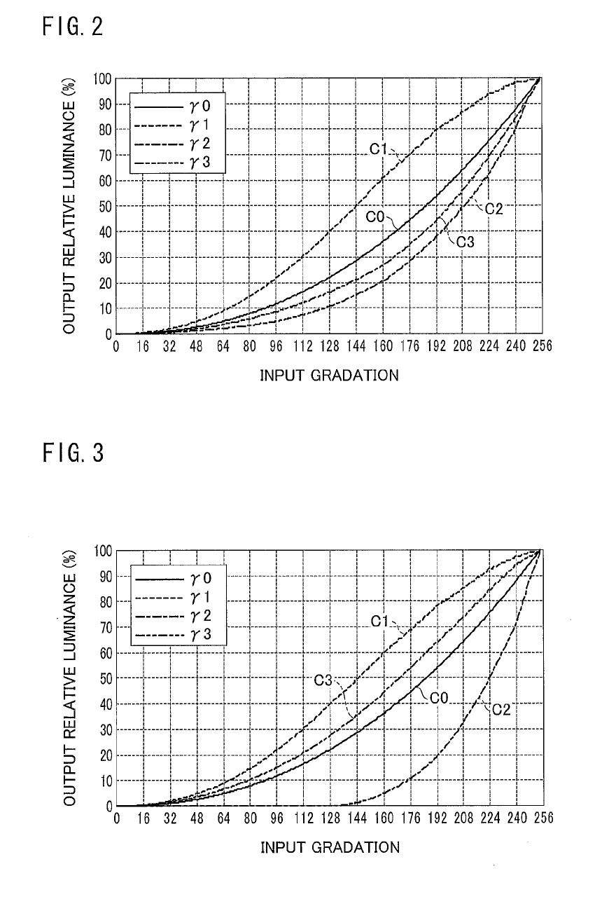

The following describes examples of the gamma curves C1, C2, and C3, with reference to FIGS. 2 through 6.

### EXAMPLE 1 OF GAMMA CURVES

FIG. 2 is a graph showing one example of the gamma curves to be used by the drive circuit of the one embodiment of the present invention.

In the Example 1 of the gamma curves, as shown in FIG. 2, an output relative luminance (hereinafter, abbreviated as “relative luminance”) corresponding to any input gradation (hereinafter, abbreviated as “gradation”) on the gamma curve C1 is higher than a relative luminance corresponding to the gradation on a target gamma curve C0 which indicates a target gamma characteristic γ0. Further, a relative luminance corresponding to any gradation on the gamma curve C2 is lower than a relative luminance corresponding to the gradation on the target gamma curve C0. This allows respective gamma characteristics γ1 and γ2 of the first and second pixel groups compensate each other effectively. As a result, a viewing angle can be increased.

Further, a relative luminance corresponding to any gradation on the gamma curve C3 is lower than a relative luminance corresponding to the gradation on the target gamma curve C0. That is, relative luminances to be outputted by the third pixel group are lower at any gradation than target relative luminances.

In the present Specification, the target gamma curve C0 which indicates the target gamma characteristic γ0 refers to a gamma curve which is used in a case where a single gamma curve is used in driving all the plurality of pixels 10 of the display panel 1. The target gamma curve C0 may also be, e.g., a gamma curve which is derived by a general method on the basis of characteristics etc. of the display apparatus 100 so that a good visibility is achieved when the display apparatus 100 is viewed from the front.

In the Examples 1 through 5 of Gamma Curves, it is preferable that an average of (i) a relative luminance corresponding to any gradation on the gamma curve C1, (ii) a relative luminance corresponding to the gradation on the gamma curve C2, and (iii) a relative luminance corresponding to the gradation on the gamma curve C3 be equal to a relative luminance corresponding to the gradation on the target gamma curve C0.

### EXAMPLE 2 OF GAMMA CURVES

FIG. 3 is a graph showing other examples of the gamma curves to be used by the drive circuit of the one embodiment of the present invention. The following mainly deals with differences between the “Example 2 of Gamma Curves” and the “Example 1 of Gamma Curves.” For convenience of explanation, constituent elements having the same function as those of the constituent elements in the “Example 1 of Gamma Curves” are given common reference numerals, and the following omits to describe such constituent elements. The same holds for “Example 3 of Gamma Curves” through “Example 5 of Gamma Curves.”

In the Example 2 of Gamma Curves, (i) a relative luminance corresponding to any gradation on the gamma curve C3 is higher than a relative luminance corresponding to the gradation on the target gamma curve C0. That is, relative luminances to be outputted by the third pixel group are higher at any gradation than the target relative luminances.

### EXAMPLE 3 OF GAMMA CURVES

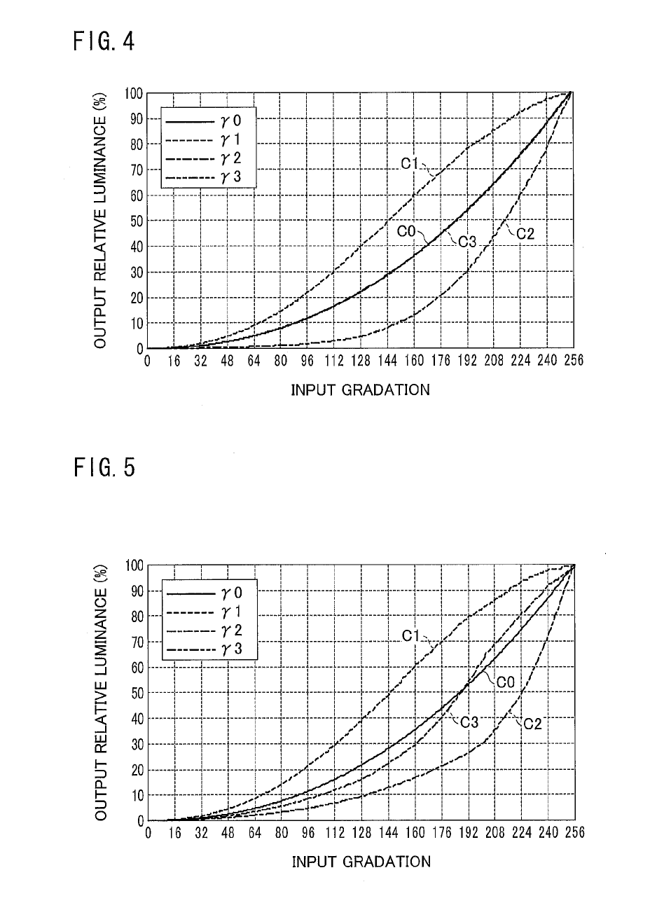

FIG. 4 is a graph showing other examples of the gamma curves to be used by the drive circuit of the one embodiment of the present invention.

In the Example 3 of the gamma curves, the gamma curve C3 is identical with the target gamma curve C0. That is, the third pixel group is driven by use of the third gamma curve C3 which is identical with the target gamma curve C0.

In the present Specification, the expression: two gamma curves are “identical with each other” may indicate that the two gamma curves are substantially identical with each other.

In the present Example, the gamma curve C1 may intersect with the target gamma curve C0 at a certain gradation (first certain gradation). In this case, for example, a relative luminance corresponding to any gradation (third gradation) on the gamma curve C1 which gradation is lower than the first certain gradation may be higher than a relative luminance corresponding to the third gradation on the target gamma curve C0. Further, a relative luminance corresponding to any gradation (fourth gradation) on the gamma curve C1 which is higher than the first certain gradation may be lower than a relative luminance corresponding to the fourth gradation on the target gamma curve C0. With the arrangement, relative luminances to be outputted by the first pixel group are higher than the target luminances at lower gradations than the first certain gradation, and are lower than the target luminances at higher gradations than the first certain gradation.

Further, the gamma curve C2 may intersect with the target gamma curve C0 at a certain gradation (second certain gradation). In this case, for example, a relative luminance corresponding to any gradation (fifth gradation) on the gamma curve C2 which gradation is lower than the second certain gradation may be lower than a relative luminance corresponding to the fifth gradation on the target gamma curve C0. Further, a relative luminance corresponding to any gradation (sixth gradation) on the gamma curve C2 which gradation is higher than the second certain gradation may be higher than a relative luminance corresponding to the sixth gradation on the target gamma curve C0. With the arrangement, relative luminances to be outputted by the second pixel group are lower than the target luminances at lower gradations than the second certain gradation, and are higher than the target luminances at higher gradations than the second certain gradation.

Further, the gradation (first certain gradation) at which the gamma curve C1 intersects with the target gamma curve C0 may be equal to the gradation (second certain gradation) at which the gamma curve C2 intersects with the target gamma curve C0.

With the arrangement, respective gamma characteristics of the first and second pixel groups compensate each other. This improves visibility in the oblique view state. As a result, a viewing angle can be increased.

The target gamma characteristic γ0 is preferably not less than 1.7 but not more than 2.7.

Further, the target gamma curve C0 may be a curve having one inflection point. This makes it possible to sharply change a gradation-luminance characteristic of a halftone area which is often contained in a natural image. As a result, a visual contrast (contrast feeling) can be increased.

Further, an average of (i) a relative luminance corresponding to any gradation on the gamma curve C1 and (ii) a relative luminance corresponding to the gradation on the gamma curve C2 is preferably equal to a relative luminance corresponding to the gradation on the target gamma curve C0. With the arrangement, respective gamma characteristics of the first and second pixel groups compensate each other more effectively. This further improves visibility.

### EXAMPLE 4 OF GAMMA CURVES

FIG. 5 is a graph showing other examples of the gamma curves to be used by the drive circuit of the one embodiment of the present invention.

In the Example 4 of the gamma curves, the gamma curve C3 intersects with the target gamma curve C0 at a certain gradation. Further, a relative luminance corresponding to any gradation (first gradation) on the gamma curve C3 which gradation is lower than the certain gradation may be lower than a relative luminance corresponding to the first gradation on the target gamma curve C0. Furthermore, a relative luminance corresponding to any gradation (second gradation) on the gamma curve C3 which gradation is higher than the certain gradation may be higher than a relative luminance corresponding to the second gradation on the target gamma curve C0. That is, relative luminances to be outputted by the third pixel group are lower than the target luminances at lower gradations than the certain gradation, and are higher than the target luminances at higher gradations than the certain gradation.

### EXAMPLE 5 OF GAMMA CURVES

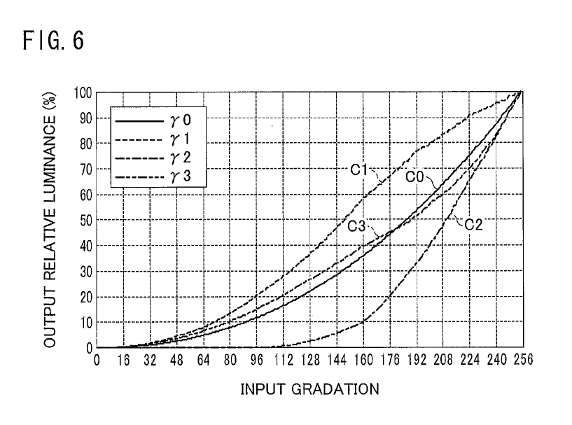

FIG. 6 is a graph showing other examples of the gamma curves to be used by the drive circuit of the one embodiment of the present invention.

In the Example 5 of the gamma curves, the gamma curve C3 intersects with the target gamma curve C0 at a certain gradation. Further, a relative luminance corresponding to any gradation (first gradation) on the gamma curve C3 which gradation is lower than the certain gradation may be higher a relative luminance corresponding to the first gradation on the target gamma curve C0. Furthermore, a relative luminance corresponding to any gradation (second gradation) on the gamma curve C3 which gradation is higher than the certain gradation may be lower than a relative luminance corresponding to the second gradation on the target gamma curve C0. That is, relative luminances to be outputted by the third pixel group are higher than the target luminances at lower gradations than the certain gradation, and are lower than the target luminances at higher gradations than the certain gradation.

The display apparatus 100 may be arranged to be switchable among the arrangements shown in the Examples 1 through 5 of the gamma curves.

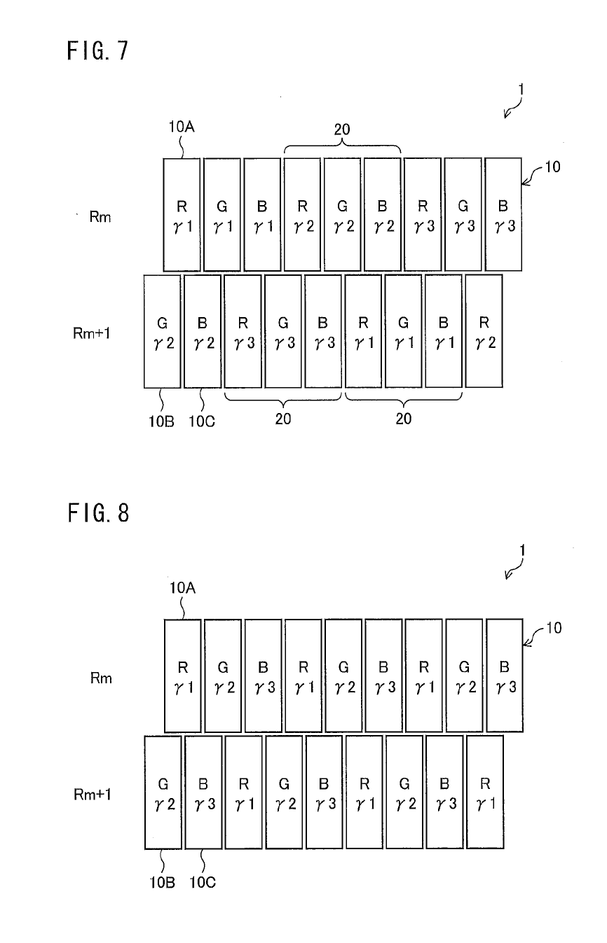

The following describes examples of disposition of the first through third pixel groups, with reference to FIGS. 7 through 13.

First, the following describes an example of a case where the first through third pixel groups are disposed on the basis of colors of the pixels.

### EXAMPLE 1 OF DISPOSITION ON THE BASIS OF COLORS

FIG. 7 is a view illustrating one example of disposition of the pixel groups of the one embodiment of the present invention.

In the Example 1 of disposition on the basis of colors, as illustrated in FIG. 7, any one of any three pixels 10 which are triangularly disposed is a red ‘R’ (first primary color) pixel 10A (a pixel of the first primary color); another one is a green ‘G’ (second primary color) pixel 10B (a pixel of the second primary color); and another one is a blue ‘B’ (third primary color) pixel 10C (a pixel of the third primary color). Accordingly, the red ‘R’ pixels 10A are disposed in a zigzag pattern. The same holds for the green ‘G’ pixels 10B and the blue ‘B’ pixels 10C. This applies to the “Examples 2 through 4 of Disposition on the Basis of Colors” below.

A pixel group made up of a red ‘R’ pixel 10A, a green ‘G’ pixel 10B, and a blue ‘B’ pixel 10C which are successively arranged in a row direction of the display panel 1 is referred to as one pixel set 20. In the Example 1 of disposition on the basis of colors, any one of any three pixel sets 20 which are triangularly disposed in the display panel 1 constitutes the first pixel group; another one constitutes the second pixel group; and another one constitutes the third pixel group. Accordingly, the first through third pixel groups are disposed in a zigzag pattern so as to each correspond to a pixel set 20 having R, G, and B pixels.

In the “Examples 1 through 4 of Disposition on the Basis of Colors,” the gate driver 2 and the source driver 3 may use the gamma curves in any of the Examples above of the gamma curves, as the gamma curves C1, C2, and C3 for driving the first through third pixel groups.

### EXAMPLE 2 OF DISPOSITION ON THE BASIS OF COLORS

FIG. 8 is a view illustrating another example of disposition of the pixel groups of the one embodiment of the present invention. The following mainly deals with differences between the Examples 1 and 2 of disposition on the basis of colors. For convenience of explanation, constituent elements having the same functions as those of the constituent elements in the “Example 1 of Disposition on the Basis of Colors” are given common reference numerals, and the following omits to describe such constituent elements. The same holds for the Examples 3 and 4 of disposition on the basis of colors.

In the Example 2 of disposition on the basis of colors, the first pixel group is made up of a red ‘R’ pixel 10A. Further, any second pixel group is made up of a green ‘G’ pixel 10B. Further, any third pixel group is made up of a blue ‘B’ pixel 100. Accordingly, each of the first through third pixel groups is disposed in a zigzag pattern so as to correspond to pixels of a single color. How the three pixel groups and the pixels of the three primary colors are combined is not limited to the above, but may vary in possible ways.

### EXAMPLE 3 OF DISPOSITION ON THE BASIS OF COLORS

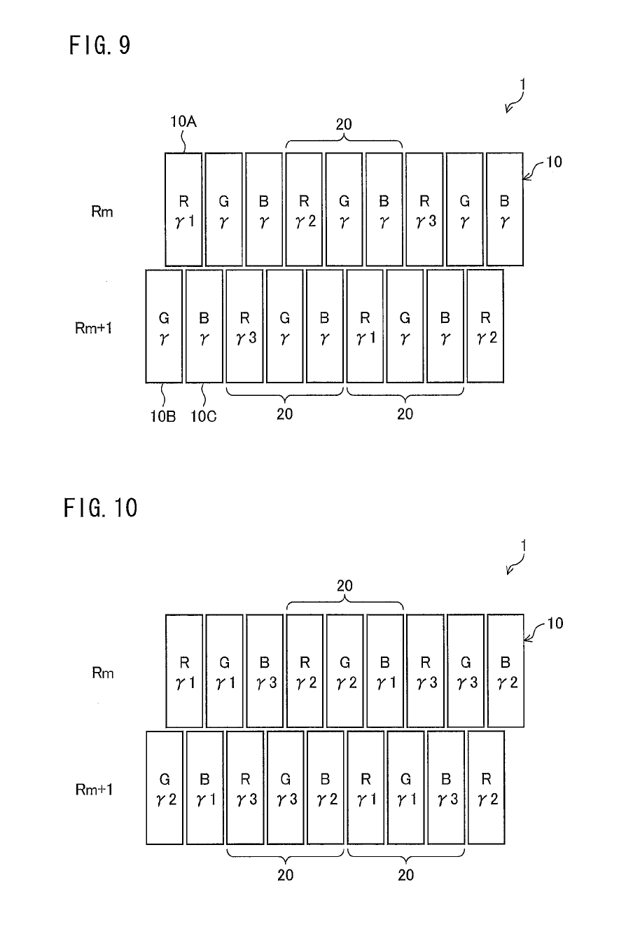

FIG. 9 is a view illustrating another example of disposition of the pixel groups of the one embodiment of the present invention.

In the Example 3 of disposition on the basis of colors, a first pixel group is constituted by a red ‘R’ pixel 10A contained in any one of any three pixel sets 20 which are triangularly disposed in the display panel 1; a second pixel group is constituted by a red ‘R’ pixel 10A contained in another one of the three pixel sets 20; and a third pixel group is constituted by a red ‘R’ pixel 10A contained in another one of the three pixel sets 20. Accordingly, the first through third pixel groups are disposed in a zigzag pattern so as to each correspond to a red ‘R’ pixel 10A by every pixel set 20.

Further, the gate driver 2 and the source driver 3 use the target gamma curve C0 which indicates the target gamma characteristic γ0, in driving the green ‘G’ pixels 10B and the blue ‘B’ pixels 10C.

That is, the first through third pixel groups are disposed in a zigzag pattern so as to each correspond to one pixel of a single color among three R, G, and B pixels.

In a case where each of the gamma curves C1, C2, and C3 is different from the target gamma curve C0, the gate driver 2 and the source driver 3 drive the plurality of pixels 10 by use of the four gamma curves: the gamma curves C1, C2, and C3 and the target gamma curve C0.

The above deals with such an example that the first through third pixel groups are disposed in a zigzag pattern so as to each correspond to a red ‘R’ pixel 10A. However, how the first through third pixel groups are disposed is not limited to this. That is, the first through third pixel groups may be disposed in a zigzag pattern so as to each correspond to a green ‘G’ pixel 10B or a blue ‘B’ pixel 10C.

Alternatively, the first through third pixel groups may be disposed in a zigzag pattern so as to each correspond to two pixels having respective colors.

For example, a modification of the mode above may be such that: a first pixel group is constituted by a red ‘R’ pixel 10A and a green ‘G’ pixel 10B which are contained in any one of any three pixel sets 20 which are triangularly disposed in the display panel 1; a second pixel group is constituted by a red ‘R’ pixel 10A and a green ‘G’ pixel 10B which are contained in another one of the three pixel sets 20; and a third pixel group is constituted by a red ‘R’ pixel 10A and a green ‘G’ pixel 10B which are contained in another one of the three pixel groups. Accordingly, the first through third pixel groups are disposed in a zigzag pattern so as to each correspond to a red ‘R’ pixel 10A and a green ‘G’ pixel 10B by every pixel set 20.

In this case, the gate driver 2 and the source driver 3 may drive the blue ‘B’ pixels 10C by use of the target gamma curve C0 which indicates the target gamma characteristic γ0.

### EXAMPLE 4 OF DISPOSITION ON THE BASIS OF COLORS

FIG. 10 is a view illustrating another example of disposition of the pixel groups of the one embodiment of the present invention.

In the Example 4 of disposition on the basis of colors, a first pixel group is constituted by a red ‘R’ pixel 10A and a green ‘G’ pixel 10B in three pixels 10 contained in any one of any three pixel sets 20 which are triangularly disposed in the display panel 1; and a third pixel group is constituted by a blue ‘B’ pixel 10C contained in the one of the three pixel sets 20. Further, a second pixel group is constituted by a red ‘R’ pixel 10A and a green ‘G’ pixel 10B in three pixels 10 contained in another one of the three pixel sets 20; and the first pixel group is constituted by a blue ‘B’ pixel 10C contained in the pixel set 20. Further, the third pixel group is constituted by a red ‘R’ pixel 10A and a green ‘G’ pixel 10B in three pixels 10 contained in another one of the three pixel sets 20; and the second pixel group is constituted by a blue ‘B’ pixel 10C contained in the pixel set 20.

Accordingly, the first through third pixel groups are disposed in a zigzag pattern so as to each correspond to a red ‘R’ pixel 10A and a green ‘G’ pixel 10B by every pixel set 20. Further, the first through third pixel groups are disposed in a zigzag pattern so as to each correspond to a blue ‘B’ pixel 10C by every pixel set 20. Further, within every pixel set 20, a red ‘R’ pixel 10A and a green ‘G’ pixel 10B constitute one pixel group and a blue ‘B’ pixel 10C constitutes another pixel group.

The above deals with such an example that within every pixel set 20, a combination of a red ‘R’ pixel 10A and a green ‘G’ pixel 10B constitutes one pixel group. However, a combination is not particularly limited to the colors.

Each of the Examples 1 through 4 of disposition on the basis of colors deals with such an arrangement that each of the pixels 10 is R, G, or B. However, the pixels 10 are not particularly limited to the colors.

The display apparatus 100 may be arranged to be switchable among the arrangements shown in the Examples 1 through 4 of disposition on the basis of colors.

The following describes distribution patterns of the first through third pixel groups.

(Distribution Pattern 1)

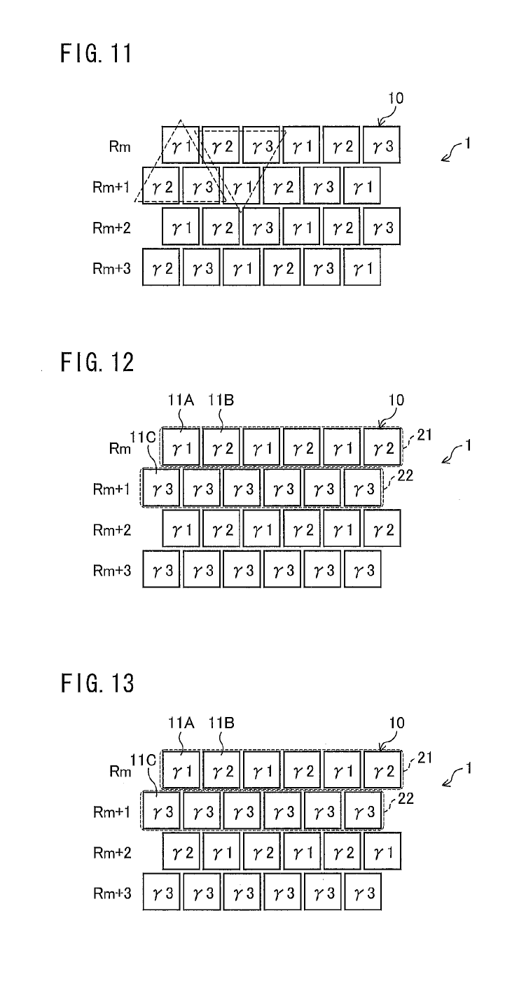

FIG. 11 is a view illustrating one example of a distribution pattern of the pixel groups of the one embodiment of the present invention.

In the distribution pattern 1, any one of any three pixels 10 which are triangularly disposed constitutes a first pixel group; another one of the three pixels 10 constitutes a second pixel group; and another one constitutes a third pixel group. This makes it possible to dispose the first through third pixel groups in a zigzag pattern.

In the distribution patterns 1 through 3, the gate driver 2 and the source driver 3 may use gamma curves in any of the Examples 1 through 5 of the gamma curves as the gamma curves C1, C2, and C3 for driving the first through third pixel groups.

(Distribution Pattern 2)

FIG. 12 is a view illustrating another example of a distribution pattern of the pixel groups of the one embodiment of the present invention. The following mainly deals with differences between the distribution patterns 1 and 2. For convenience of explanation, constituent elements having the same functions as those of the constituent elements in the “Distribution pattern 1” are given common reference numerals, and the following omits to describe such constituent elements.

In the distribution pattern 2, as illustrated in FIG. 12, disposed in each of pixel rows Rm and Rm+2 in the display panel 1 is a pixel row 21 (first pixel row) in which pixels 11A (first pixels) constituting the first pixel group and pixels 11B (second pixels) constituting the second pixel group are alternately disposed. Disposed in each of pixel rows Rm+1 and Rm+3 is a pixel row 22 (second pixel row) in which only pixels 11C (third pixels) are disposed which constitute the third pixel group. Accordingly, the pixel rows 21 and 22 are alternately disposed in a line direction.

Further, a pixel 11A is disposed in a position in a certain line and in a pixel row 21 (the pixel row Rm in this example) followed by any (the pixel row Rm+1 in this example) of the pixel rows 22; a pixel 11B is disposed in a position in a line next to the certain line; a pixel 11A is disposed in a position in the certain line and in a pixel row 21 (the pixel row Rm+2 in this example) which follows the any of the pixel rows 22; and a pixel 11B is disposed in a position in a line next to the certain line.

In the distribution pattern 2, the gate driver 2 and source driver 3 preferably use, as the gamma curve C3, one which is identical with the target gamma curve C0. That is, the gate driver 2 and the source driver 3 preferably use the gamma curves in the “Example 4 of Gamma Curves,” as the gamma curves C1, C2, and C3.

(Distribution Pattern 3)

FIG. 13 is a view illustrating another example of a distribution pattern of the pixel groups of the one embodiment of the present invention. The following mainly deals with differences between the distribution patterns 2 and 3. For convenience of explanation, constituent elements having the same functions as those of the constituent elements in the “Distribution pattern 2” are given common reference numerals, and the following omits to describe such constituent elements.

In the distribution pattern 3, a pixel 11A is disposed in a position in a certain line and in a pixel row 21 (the pixel row Rm in this example) followed by any (the pixel row Rm+1 in this example) of the pixel rows 22; a pixel 11B is disposed in a position in a line next to the certain line; a pixel 11B is disposed in a position in the certain line and in a pixel row 21 (the pixel row Rm+2 in this example) which follows the any of the pixel rows 22; and a pixel 11A is disposed in a position in a line next to the certain line.

The display apparatus 100 may be arranged to be switchable among the disposition patterns 1 through 3.

The following describes examples of how dispositions of the first through third pixel groups are switched frame by frame, with reference to drawings. A “frame Fn+1” indicates a frame which follows a frame Fn; a “frame Fn+2” indicates a frame which follows the frame Fn+1; a “frame Fn+3” indicates a frame which follows the frame Fn+2; and a “frame Fn+4” indicates a frame which follows the frame Fn+3.

(Frame-by-Frame Disposition Switching 1)

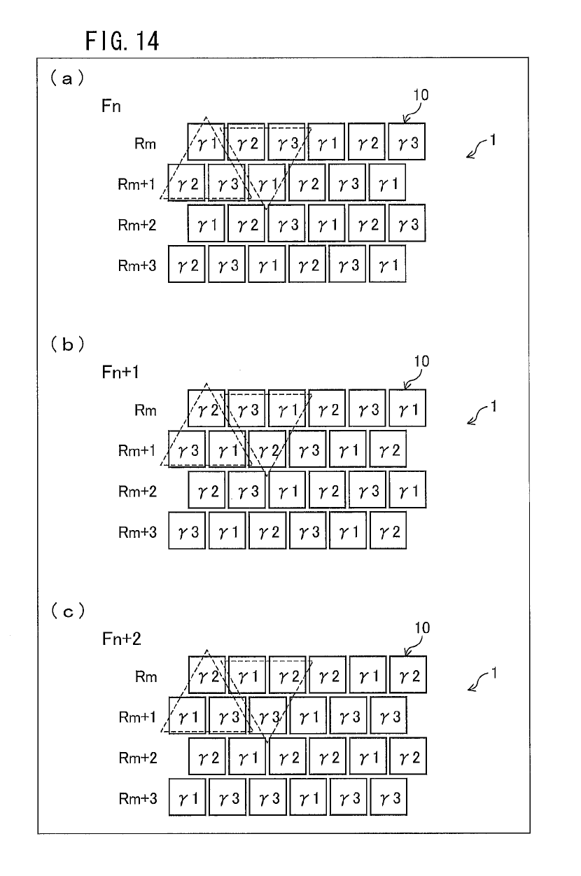

(a) through (c) of FIG. 14 are views illustrating one example of how the dispositions of the pixel groups are switched frame by frame in the one embodiment of the present invention. (a) of FIG. 14 is a view illustrating dispositions of the pixel groups in the frame Fn. (b) of FIG. 14 is a view illustrating dispositions of the pixel groups in the frame Fn+1. (c) of FIG. 14 is a view illustrating dispositions of the pixel groups in the frame Fn+2. The following deals with an example of how the dispositions in the “Distribution Pattern 1” above are switched frame by frame.

In the frame-by-frame disposition switching 1: in a case where the gate driver 2 and the source driver 3 use the gamma curve C1 in a frame (the frame Fn in this example), the gate driver 2 and the source driver 3 use the gamma curve C2 in the next frame Fn+1; in a case where the gate driver 2 and the source driver 3 use the gamma curve C2 in the frame Fn, the gate driver 2 and the source driver 3 use the gamma curve C3 in the next frame Fn+1; and in a case where the gate driver 2 and the source driver 3 use the gamma curve C3 in the frame Fn, the gate driver 2 and the source driver 3 use the gamma curve C1 in the next frame Fn+1.

That is, for each of the plurality of pixels 10, the three gamma curves C1, C2, and C3 are switched frame by frame one after the other.

(Frame-by-Frame Disposition Switching 2)

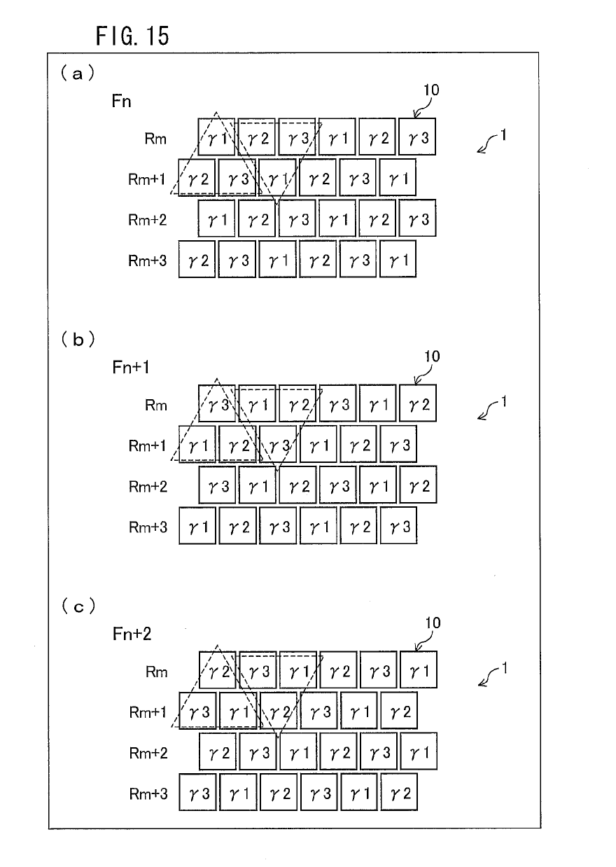

(a) through (c) of FIG. 15 are views illustrating another example of how the dispositions of the pixel groups are switched frame by frame in the one embodiment of the present invention. (a) of FIG. 15 is a view illustrating dispositions of the pixel groups in the frame Fn. (b) of FIG. 15 is a view illustrating dispositions of the pixel groups in the frame Fn+1. (c) of FIG. 15 is a view illustrating dispositions of the pixel groups in the frame Fn+2. The following deals with an example of how the dispositions in the “Distribution Pattern 1” above are switched frame by frame.

In the frame-by-frame disposition switching 2: in a case where the gate driver 2 and the source driver 3 use the gamma curve C1 in a frame (the frame Fn in this example), the gate driver 2 and the source driver 3 use the gamma curve C3 in the next frame Fn+1; in a case where the gate driver 2 and the source driver 3 use the gamma curve C2 in a frame Fn, the gate driver 2 and the source driver 3 use the gamma curve C1 in the next frame Fn+1; and in a case where the gate driver 2 and the source driver 3 use the gamma curve C3 in the frame Fn, the gate driver 2 and the source driver 3 use the gamma curve C2 in the next frame Fn+1.

That is, for each of the plurality of pixels 10, the three gamma curves C1, C2, and C3 are switched frame by frame one after the other.

(Frame-by-Frame Disposition Switching 3)

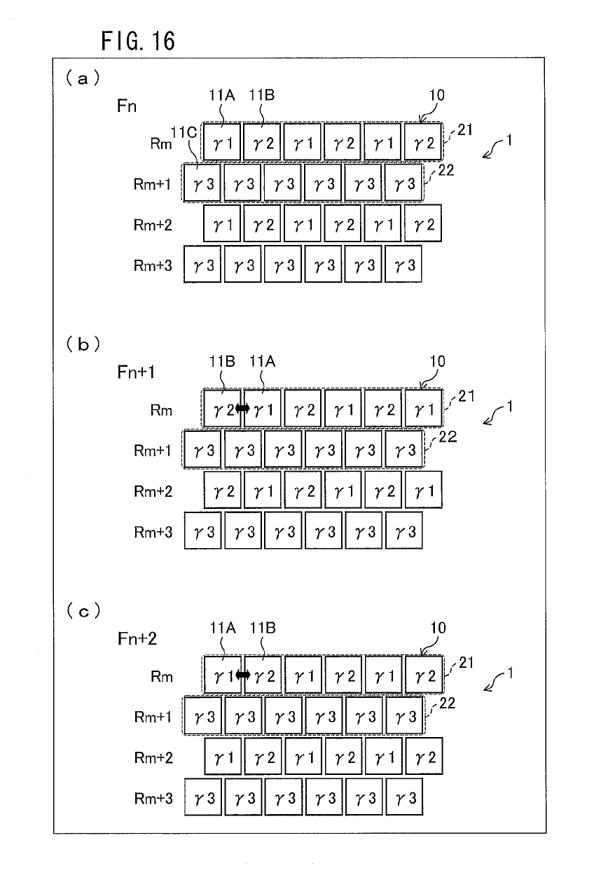

(a) through (c) of FIG. 16 are views illustrating another example of how the dispositions of the pixel groups are switched frame by frame in the one embodiment of the present invention. (a) of FIG. 16 is a view illustrating dispositions of the pixel groups in the frame Fn. (b) of FIG. 16 is a view illustrating dispositions of the pixel groups in the frame Fn+1. (c) of FIG. 16 is a view illustrating dispositions of the pixel groups in the frame Fn+2. The following deals with an example of how the dispositions in the “Distribution Pattern 2” above are switched frame by frame.

In the frame-by-frame disposition switching 3: in a case where the gate driver 2 and the source driver 3 use the gamma curve C1 in a frame (the frame Fn in this example), the gate driver 2 and the source driver 3 use the gamma curve C2 in the next frame Fn+1; in a case where the gate driver 2 and the source driver 3 use the gamma curve C2 in the frame Fn, the gate driver 2 and the source driver 3 use the gamma curve C1 in the next frame Fn+1; and in a case where the gate driver 2 and the source driver 3 use the gamma curve C3 in the frame Fn, the gate driver 2 and the source driver 3 use the gamma curve C3 in the next frame Fn+1.

That is, each of the pixels 10 in the pixel rows 21 (the pixel rows Rm and Rm+2 in this example) alternately switches between the two gamma curves C1 and C2 frame by frame.

Although the above deals with the example of how the dispositions of the “Distribution Pattern 2” are switched frame by frame, the dispositions of the “Distribution Pattern 3” may be alternatively switched frame by frame in the same manner above.

(Frame-by-Frame Disposition Switching 4)

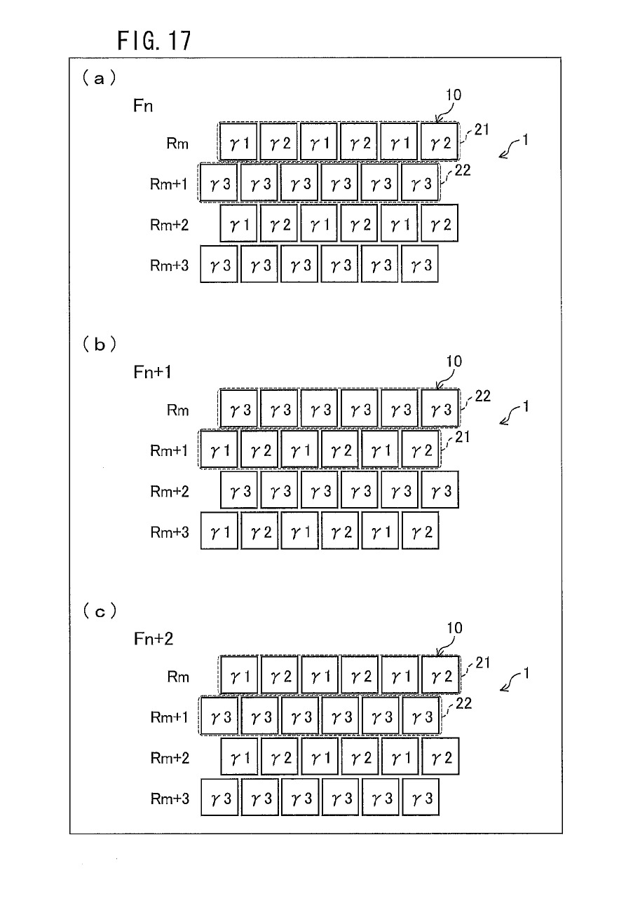

(a) through (c) of FIG. 17 are views illustrating another example of how the dispositions of the pixel groups are switched frame by frame in the one embodiment of the present invention. (a) of FIG. 17 is a view illustrating dispositions of the pixel groups in the frame Fn. (b) of FIG. 17 is a view illustrating dispositions of the pixel groups in the frame Fn+1. (c) of FIG. 17 is a view illustrating dispositions of the pixel groups in the frame Fn+2. The following deals with an example of how the dispositions in the “Distribution Pattern 2” above are switched frame by frame.

In the frame-by-frame disposition switching 4: in a case where the gate driver 2 and the source driver 3 use the gamma curve C1 or C2 in a frame (the frame Fn+1 in this example), the gate driver 2 and the source driver 3 use the gamma curve C3 in the next frame Fn+2; in a case where the gate driver 2 and the source driver 3 use the gamma curve C3 in the frame Fn+1 and use the gamma curve C1 in the previous frame Fn, the gate driver 2 and the source driver 3 use the gamma curve C1 in the next frame Fn+2; and in a case where the gate driver 2 and the source driver 3 use the gamma curve C3 in the frame Fn+1 and use the gamma curve C2 in the previous frame Fn, the gate driver 2 and the source driver 3 use the gamma curve 02 in the next frame Fn+2.

That is, each of the pixel rows switches, frame by frame, between a case where the pixel row is a pixel row 21 and a case where the pixel row is a pixel row 22.

Although the above deals with the example of how the dispositions of the “Distribution Pattern 2” are switched frame by frame, the dispositions of the “Distribution Pattern 3” may be alternatively switched frame by frame in the same manner above.

(Frame-by-Frame Disposition Switching 5)

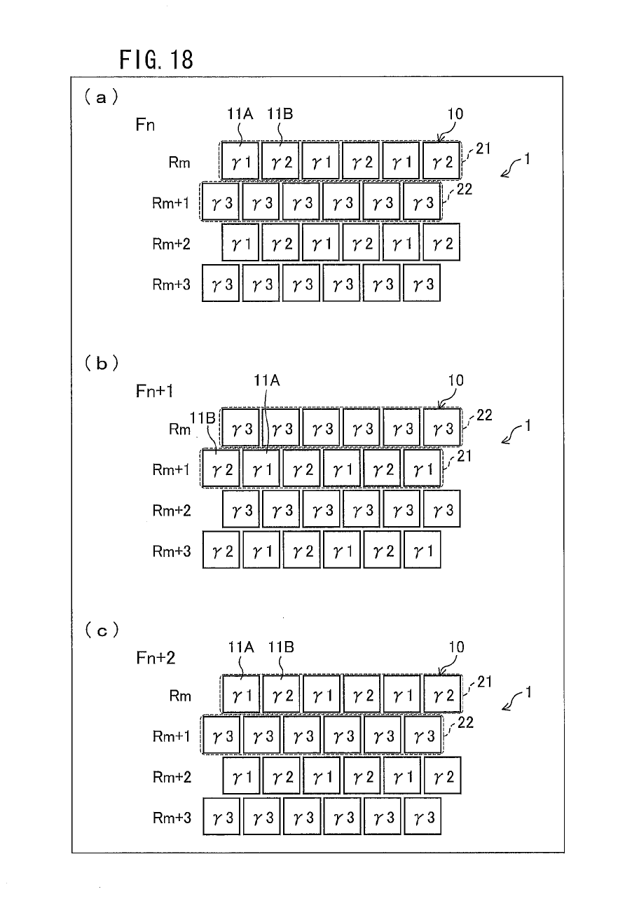

(a) through (c) of FIG. 18 are views illustrating another example of how the dispositions of the pixel groups are switched frame by frame in the one embodiment of the present invention. (a) of FIG. 18 is a view illustrating dispositions of the pixel groups in the frame Fn. (b) of FIG. 18 is a view illustrating dispositions of the pixel groups in the frame Fn+1. (c) of FIG. 18 is a view illustrating dispositions of the pixel groups in the frame Fn+2. The following mainly deals with differences between the frame-by-frame disposition switchings 4 and 5. For convenience of explanation, constituent elements having the same functions as those of the constituent elements in the frame-by-frame disposition switching 4 are given common reference numerals, and the following omits to describe such constituent elements.

In the frame-by-frame disposition switching 5, pixels 11A and pixels 11B are positionally shifted by one line between pixel rows 21 (the pixel rows Rm+1 and Rm+3 in this example) in a frame (the frame Fn+1 in this example) and pixel rows 21 (the pixel rows Rm and Rm+2 in this example) in the next frame (the frame Fn+2 in this example).

For example, adjacent pixel rows 21 and 22 are interchanged frame by frame between an odd-numbered row (e.g., the pixel row Rm) and the next even-numbered row (e.g., the pixel row Rm+1), and at the same time, adjacent pixels 11A and 11B are interchanged in the pixel row 21.

Although the above deals with the example of how the dispositions of the “Distribution Pattern 2” are switched frame by frame, the dispositions of the “Distribution Pattern 3” may be alternatively switched frame by frame in the same manner above.

(Frame-by-Frame Disposition Switching 6)

(a) through (e) of FIG. 19 are views illustrating another example of how the dispositions of the pixel groups are switched frame by frame in the one embodiment of the present invention. (a) of FIG. 19 is a view illustrating dispositions of the pixel groups in the frame Fn. (b) of FIG. 19 is a view illustrating dispositions of the pixel groups in the frame Fn+1. (c) of FIG. 19 is a view illustrating dispositions of the pixel groups in the frame Fn+2. (d) of FIG. 19 is a view illustrating dispositions of the pixel groups in the frame Fn+3. (e) of FIG. 19 is a view illustrating dispositions of the pixel groups in the frame Fn+4. The following deals with an example of how the dispositions in the “Distribution Patterns 2” are switched frame by frame.

In the frame-by-frame disposition switching 6: in a case where the gate driver 2 and the source driver 3 use the gamma curve C1 or C2 in a frame (the frame Fn+1 in this example), the gate driver 2 and the source driver 3 use the gamma curve C3 in the next frame Fn+2; in a case where the gate driver 2 and the source driver 3 use the gamma curve C3 in the frame Fn+1 and use the gamma curve C1 in the previous frame Fn, the gate driver 2 and the source driver 3 use the gamma curve C2 in the next frame Fn+2; and in a case where the gate driver 2 and the source driver 3 use the gamma curve C3 in the frame Fn+1 and use the gamma curve C2 in the previous frame Fn, the gate driver 2 and the source driver 3 use the gamma curve C1 in the next frame Fn+2.

That is, each of the pixel rows switches, frame by frame, between a case where the pixel row is a pixel row 21 and a case where the pixel row is a pixel row 22. In a pixel row 21 which is disposed in any pixel row in every two frames, any two adjacent pixels 11A and 11B are interchanged in every two frames.

Although the above deals with the example of how the dispositions of the “Distribution Pattern 2” are switched frame by frame, the dispositions of the “Distribution Pattern 3” may be alternatively switched frame by frame in the same manner above.

(Frame-by-Frame Disposition Switching 7)

(a) through (c) of FIG. 20 are views illustrating another example of how the dispositions of the pixel groups are switched frame by frame in the one embodiment of the present invention. (a) of FIG. 20 is a view illustrating dispositions of the pixel groups in the frame Fn. (b) of FIG. 20 is a view illustrating dispositions of the pixel groups in the frame Fn+1. (c) of FIG. 20 is a view illustrating dispositions of the pixel groups in the frame Fn+2. The following mainly deals with differences between the frame-by-frame disposition switchings 3 and 7. For convenience of explanation, constituent elements having the same functions as those of the constituent elements in the frame-by-frame disposition switching 3 are given common reference numerals, and the following omits to describe such constituent elements.

The frame-by-frame disposition switching 7 is different from the frame-by-frame disposition switching 3 in that the dispositions in the “Distribution Pattern 1” are switched frame by frame. How the gamma curves C1, C2, and C3 are switched is the same as the “Frame-by-frame Disposition Switching 3.”

That is, as illustrated in (a) through (c) of FIG. 20, the plurality of pixels 10 are made up of pixels 10 for which the two gamma curves C1 and C2 are alternately used frame by frame and pixels 10 for which the gamma curve C3 is always used.

The display apparatus 100 may be further arranged to be switchable among the frame-by-frame disposition switching 1 through 7.

The gate driver 2 and the source driver 3 may drive the display panel 1 at a frame frequency higher than a frame frequency at which an image signal is supplied to the display apparatus 100.

Further, the gate driver 2 and the source driver 3 may drive the display panel 1 at a frame frequency which is three or two times ±10% higher than a frame frequency at which an image signal is supplied to the display apparatus 100.

Further, in a case where the display apparatus 100 includes an input interface compliant with an NTSC standard, and an image signal is supplied via the input interface, the gate driver 2 and the source driver 3 may drive the display panel 1 at a frame frequency higher than 60 Hz in the “Frame-by-frame disposition switchings 1 through 7.”

Further, in a case where the display apparatus includes the input interface compliant with the NTSC standard, and an image signal is supplied via the input interface, the gate driver 2 and the source driver 3 may drive the display panel 1 at a frame frequency of 180 Hz±10% in the “Frame-by-frame disposition switchings 1 and 2.”

Further, in the “Frame-by-frame disposition switchings 3 through 7,” the gate driver 2 and the source driver 3 may drive the display panel 1 at a frame frequency of 120 Hz±10%.

Further, in a case where the display apparatus 100 includes an input interface compliant with a PAL standard, and an image signal is supplied via the input interface, the gate driver 2 and the source driver 3 may drive the display panel 1 at a frame frequency higher than 50 Hz in the “Frame-by-frame disposition switchings 1 through 7.”

Further, in the “Frame-by-frame disposition switchings 1 and 2,” the gate driver 2 and the source driver 3 may drive the display panel 1 at a frame frequency of 150 Hz±10%.

Further, in the “Frame-by-frame disposition switchings 3 through 7,” the gate driver 2 and the source driver 3 may drive the display panel 1 at a frame frequency of 100 Hz±10%.

Further, the display apparatus 100 may be arrange to be switchable between a mode in which the first through third pixel groups are disposed in the pixels 10 by the various methods above and a mode in which all the pixels 10 are driven by use of a single gamma curve which indicates a single gamma characteristic.

Further, the display apparatus 100 may be arrange to be switchable between a mode in which the first through third pixel groups are disposed in the pixels 10 by the various methods above and a mode in which as shown in FIGS. 21 and 22, the pixels 10 are driven by use of two gamma curves which respectively indicates two gamma characteristics.

Further, the display apparatus 100 may be arrange to be switchable among (i) a mode in which the first through third pixel groups are disposed in the pixels 10 by the various methods above, (ii) a mode in which as shown in FIGS. 21 and 22, the pixels 10 are driven by use of two gamma curves which respectively indicates two gamma characteristics, and (iii) a mode in which all the pixels 10 are driven by use of a single gamma curve which indicates a single gamma characteristic.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

For example, the display apparatus of the present invention is preferably arranged such that: a relative luminance corresponding to a gradation on the first gamma curve is higher than a relative luminance corresponding to the gradation on a target gamma curve which indicates a target gamma characteristic; and a relative luminance corresponding to a gradation on the second gamma curve is lower than a relative luminance corresponding to the gradation on the target gamma curve.

The arrangement allows respective gamma characteristics of the first and second pixel groups to effectively compensate each other. As a result, a viewing angle can be increased.

Further, the display apparatus of the present invention is preferably arranged such that: a relative luminance corresponding to a gradation on the third gamma curve is higher than a relative luminance corresponding to the gradation on the target gamma curve.

Further, the display apparatus of the present invention is preferably arranged such that: a relative luminance corresponding to a gradation on the third gamma curve is lower than a relative luminance corresponding to the gradation on the target gamma curve.

According to the arrangement, a relative luminance to be outputted by the third pixel group is lower than a target relative luminance at any gradation. This makes it possible to prevent increase in visual luminance in the oblique view state.

Further, the display apparatus of the present invention is preferably arranged such that: the third gamma curve intersects with the target gamma curve at a certain gradation; a relative luminance corresponding to a first gradation which is any gradation on the third gamma curve lower than the certain gradation is lower than a relative luminance corresponding to the first gradation on the target gamma curve; and a relative luminance corresponding to a second gradation which is any gradation on the third gamma curve higher than the certain gradation is higher than a relative luminance corresponding to the second gradation on the target gamma curve.

Further, the display apparatus of the present invention is preferably arranged such that: the third gamma curve intersects with the target gamma curve at a certain gradation; a relative luminance corresponding to a first gradation which is any gradation on the third gamma curve higher than the certain gradation is lower than a relative luminance corresponding to the first gradation on the target gamma curve; and a relative luminance corresponding to a second gradation which is any gradation on the third gamma curve lower than the certain gradation is higher than a relative luminance corresponding to the second gradation on the target gamma curve.

Further, the display apparatus of the present invention is preferably arranged such that: an average of (i) a relative luminance corresponding to a gradation on the first gamma curve, (ii) a relative luminance corresponding to the gradation on the second gamma curve, and (iii) a relative luminance corresponding to the gradation on the third gamma curve is equal to a relative luminance corresponding to the gradation on the target gamma curve.

The arrangement makes it possible to equalize a frontal visibility with one for the case where all the pixels are driven by use of the target gamma curve, and also further improve the visibility in the oblique view state.

Further, the display apparatus of the present invention is preferably arranged such that: the third gamma curve is identical with the target gamma curve.

According to the arrangement, the third pixel group is driven by use of the third gamma curve identical with the target gamma curve. This makes it possible to prevent a bright point and/or a dark point from being displayed, so that deterioration in resolution feeling is prevented.

Further, the display apparatus of the present invention is preferably arranged such that: the first gamma curve intersects with the target gamma curve at a first certain gradation; a relative luminance corresponding to a third gradation which is any gradation on the first gamma curve lower than the first certain gradation is higher than a relative luminance corresponding to the third gradation on the target gamma curve; a relative luminance corresponding to a fourth gradation which is any gradation on the first gamma curve higher than the first certain gradation is lower than a relative luminance corresponding to the fourth gradation on the target gamma curve; the second gamma curve intersects with the target gamma curve at a second certain gradation; a relative luminance corresponding to a fifth gradation which is any gradation on the second gamma curve lower than the second certain gradation is lower than a relative luminance corresponding to the fifth gradation on the target gamma curve; a relative luminance corresponding to a sixth gradation which is any gradation on the second gamma curve higher than the second certain gradation is higher than a relative luminance corresponding to the sixth gradation on the target gamma curve; and the third gamma curve is identical with the target gamma curve.

Further, the display apparatus of the present invention is preferably arranged such that: the first certain gradation and the second certain gradation are equal to each other.

According to the arrangement, the first certain gradation and the second certain gradation are equal to each other. This allows the drive circuit to have a smaller circuit configuration. In addition, an effect of increasing a viewing angle can be obtained as in the case where the first certain gradation and the second certain gradation are different.

Further, the display apparatus of the present invention is preferably arranged such that: the target gamma characteristic is not less than 1.7 but no more than 2.7.

The arrangement makes it possible to improve visibility.

Further, the display apparatus of the present invention is preferably arranged such that: the target gamma curve is a curve having one inflection point.

According to the arrangement, a gradation-luminance characteristic of a halftone area is sharply changed. This increases visual contrast (contrast feeling). As a result, visibility can be improved.

Further, the display apparatus of the present invention is preferably arranged such that: an average of (i) a relative luminance corresponding to a gradation on the first gamma curve and (ii) a relative luminance corresponding to the gradation on the second gamma curve is equal to a relative luminance corresponding to the gradation on the target gamma curve.

The arrangement allows respective gamma characteristics of the first and second pixel groups to effectively compensate each other. As a result, visibility can be improved further.

Further, the display apparatus of the present invention is preferably arranged such that: among three pixels which are any three pixels in the plurality of pixels and which are triangularly disposed, any pixel is a pixel of a first primary color; another pixel is a pixel of a second primary color which is different from the first primary color; and another pixel is a pixel of a third primary color which is different from each of the first primary color and the second primary color.

Further, the display apparatus of the present invention is preferably arranged such that: a pixel group made up of a pixel of the first primary color, a pixel of the second primary color, and a pixel of the third primary color, which are successively disposed in a row direction of the display panel, corresponds to one pixel set; all pixels contained in any one of any three pixel sets which are triangularly disposed in the display panel constitute the first pixel group; all pixels contained in another one of the any three pixel sets constitute the second pixel group; and all pixels contained in another one of the any three pixel sets constitute the third pixel group.

According to the arrangement, the first through third pixel groups are disposed in a zigzag pattern so as to each correspond to a pixel set. This makes it possible to alleviate increase in visual luminance in the oblique view state. This makes it possible to further increase a viewing angle in both the vertical direction and the horizontal direction of the display panel, so that visibility can be improved.

Further, the display apparatus of the present invention is preferably arranged such that: the first pixel group is made up of pixels of the first primary color; the second pixel group is made up of pixels of the second primary color; and the third pixel group is made up of pixels of the first primary color.

According to the arrangement, each of the first through third pixel groups are disposed in a zigzag pattern so as to correspond to pixels of a primary color. This makes it possible to alleviate increase in visual luminance in the oblique view state. This makes it possible to further increase a viewing angle in both the vertical direction and the horizontal direction of the display panel, so that visibility can be improved further. Further, reduced is a pitch at which a bright area and a dark area alternate. This makes it possible to prevent deterioration in resolution feeling.

Further, the display apparatus of the present invention is preferably arranged such that: a pixel group made up of a pixel of the first primary color, a pixel of the second primary color, and a pixel of the third primary color, which are successively disposed in a row direction of the display panel, corresponds to one pixel set; a pixel of the first primary color which pixel is contained in any one of any three pixel sets which are triangularly disposed in the display panel constitutes the first pixel group; a pixel of the first primary color which pixel is contained in another one of the any three pixel sets constitutes the second pixel group; a pixel of the first primary color which pixel is contained in another one of the any three pixel sets constitutes the third pixel group; and in driving the pixels of the second primary color and the pixel of the third primary color, the drive circuit uses the target gamma curve which indicates the target gamma characteristic.

According to the arrangement, the first through third pixel groups are disposed in a zigzag pattern so as to each correspond to a pixel of the first primary color by every pixel set. As for the pixels of the first primary color, this makes it possible to alleviate increase in visual luminance in the oblique view state. This makes it possible to further increase a viewing angle in both the vertical direction and the horizontal direction of the display panel, so that visibility can be improved further. For example, the arrangement is suitably applicable in a case where a thickness of a liquid crystal layer differs among the first through third primary colors of the pixels, and visual luminance of only the pixels of the first primary color is increased in the oblique view state. Further, the arrangement produces such an effect that a simpler drive circuit can be employed, as compared to a case where the three different gamma curves are used to drive all the pixels of the first through third primary colors.

Further, the display apparatus of the present invention is preferably arranged such that: a pixel group made up of a pixel of the first primary color, a pixel of the second primary color, and a pixel of the third primary color, which are successively disposed in a row direction of the display panel, corresponds to one pixel set; a pixel of the first primary color and a pixel of the second primary color which are contained in any one of any three pixel sets which are triangularly disposed in the display panel constitutes the first pixel group; a pixel of the first primary color and a pixel of the second primary color which are contained in another one of the any three pixel sets constitutes the second pixel group; a pixel of the first primary color and a pixel of the second primary color which are contained in another one of the any three pixel sets constitutes the third pixel group; and in driving the pixels of the third primary color, the drive circuit uses the target gamma curve which indicates the target gamma characteristic.

According to the arrangement, the first through third pixel groups are disposed in a zigzag pattern so as to each correspond to a pixel of the first primary color and a pixel of the second primary color by every pixel set. This makes it possible to alleviate increase in visual luminance in the oblique view state. This makes it possible to further increase a viewing angle in both the vertical direction and the horizontal direction of the display panel, so that visibility can be improved further.

Further, the display apparatus of the present invention is preferably arranged such that: a pixel group made up of a pixel of the first primary color, a pixel of the second primary color, and a pixel of the third primary color, which are successively disposed in a row direction of the display panel, corresponds to one pixel set; among three pixels which are contained in any one of any three pixel sets which are triangularly disposed in the display panel, a pixel of the first primary color and a pixel of the second primary color constitute the first pixel group, and a pixel of the third primary color constitutes the third pixel group; among three pixels which are contained in another one of the any three pixel sets, a pixel of the first primary color and a pixel of the second primary color constitute the second pixel group, and a pixel of the third primary color constitutes the first pixel group; and among three pixels which are contained in another one of the any three pixel sets, a pixel of the first primary color and a pixel of the second primary color constitute the third pixel group, and a pixel of the third primary color constitutes the second pixel group.

According to the arrangement, the first through third pixel groups are disposed in a zigzag pattern so as to each correspond to a pixel of the first primary color and a pixel of the second primary color by every pixel set. In addition, the first through third pixel groups are disposed in a zigzag pattern so as to each correspond to a pixel of the third primary color by every pixel set. This makes it possible to alleviate increase in visual luminance in the oblique view state. This makes it possible to further increase a viewing angle in both the vertical direction and the horizontal direction of the display panel. Further, within one pixel set, a pixel of the first primary color and a pixel of the second primary color constitute one pixel group, and a pixel of the third primary color constitutes another pixel group. This makes it possible to prevent deterioration in resolution feeling.

Further, the display apparatus of the present invention is preferably arranged such that: among three pixels which are any three pixels in the plurality of pixels and which are triangularly disposed, any pixel constitutes the first pixel group; another pixel constitutes the second pixel group; and another pixel constitutes the third pixel group.

According to the arrangement, the first through third pixel groups are disposed in a zigzag pattern. This allows respective gamma characteristics of the pixels to compensate each other more effectively. This makes it possible to further increase a viewing angle in both the vertical direction and the horizontal direction of the display panel.

Further, the display apparatus of the present invention is preferably arranged such that: first pixel rows and second pixel rows are alternately disposed in the display panel; first pixels constituting the first pixel group and second pixels constituting the second pixel group are alternately disposed in each of the first pixel rows; and only third pixels constituting the third pixel group are disposed in each of the second pixel rows.

According to the arrangement, the first pixel groups and the second pixel groups are alternately disposed, and further, the first pixel rows and the second pixel rows are alternately disposed. This allows respective gamma characteristics of the pixels to compensate each other more effectively. This makes it possible to further increase a viewing angle in both the vertical direction and the horizontal direction of the display panel.

Further, the display apparatus of the present invention is preferably arranged such that: in a first pixel row which is followed by any second pixel row, a first pixel is disposed in a certain line and a second pixel is disposed in a line next to the certain line; and

in a first pixel row which follows the any second pixel row, a first pixel is disposed in the certain line and a second pixel is disposed in the line next to the certain line.

This allows respective gamma characteristics of the pixels to compensate each other more effectively. This makes it possible to further increase a viewing angle in the horizontal direction of the display panel.

Further, the display apparatus of the present invention is preferably arranged such that: in a first pixel row which is followed by any second pixel row, a first pixel is disposed in a certain line and a second pixel is disposed in a line next to the certain line; and in a first pixel row which follows the any second pixel row, a second pixel is disposed in the certain line and a first pixel is disposed in the line next to the certain line.

The arrangement makes it possible to obtain a viewing angle compensation effect between a pixel row which is followed by a second pixel row and a pixel row which follows the second pixel row. This allows respective gamma characteristics of the pixels to compensate each other more effectively. This makes it possible to further increase a viewing angle in both the vertical direction and the horizontal direction of the display panel. Furthermore, it is possible to prevent a bright line and a dark line from being displayed.

Further, the display apparatus of the present invention is preferably arranged such that: in driving each of the plurality of pixels, in a case where the drive circuit uses the first gamma curve in a certain frame, the drive circuit uses the second gamma curve in a next frame; in a case where the drive circuit uses the second gamma curve in the certain frame, the drive circuit uses the third gamma curve in the next frame; and in a case where the drive circuit uses the third gamma curve in the certain frame, the drive circuit uses the first gamma curve in the next frame.

According to the arrangement, in every frame, a different one of the three different gamma curves is used for each of the pixels. This produces a viewing angle compensation effect along a temporal axis. This makes it possible to improve visibility in the oblique view state and display a smooth video image. In addition, it is possible to prevent deterioration in resolution feeling.

Further, the display apparatus of the present invention is preferably arranged such that: in driving each of the plurality of pixels, in a case where the drive circuit uses the first gamma curve in a certain frame, the drive circuit uses the third gamma curve in a next frame; in a case where the drive circuit uses the second gamma curve in the certain frame, the drive circuit uses the first gamma curve in the next frame; and in a case where the drive circuit uses the third gamma curve in the certain frame, the drive circuit uses the second gamma curve in the next frame.

According to the arrangement, in every frame, a different one of the three different gamma curves is used for each of the pixels. This produces a viewing angle compensation effect along a temporal axis. This makes it possible to improve visibility in the oblique view state and display a smooth video image. In addition, it is possible to prevent deterioration in resolution feeling.

Further, the display apparatus of the present invention is preferably arranged such that: in driving each of the plurality of pixels, in a case where the drive circuit uses the first gamma curve in a certain frame, the drive circuit uses the second gamma curve in a next frame; in a case where the drive circuit uses the second gamma curve in the certain frame, the drive circuit uses the first gamma curve in the next frame; and in a case where the drive circuit uses the third gamma curve in the certain frame, the drive circuit uses the third gamma curve in the next frame.

According to the arrangement, in every frame, the first and second gamma curves are alternately used in driving the pixels. This makes it possible to improve visibility in the oblique view state and display a smooth video image.

Further, the display apparatus of the present invention is preferably arranged such that: in driving each of the plurality of pixels, in a case where the drive circuit uses the first gamma curve or the second gamma curve in a certain frame, the drive circuit uses the third gamma curve in a next frame; in a case where the drive circuit uses the third gamma curve in the certain frame, and uses the first gamma curve in a previous frame, the drive circuit uses the first gamma curve in the next frame; and in a case where the drive circuit uses the third gamma curve in the certain frame and uses the second gamma in the previous frame, the drive circuit uses the second gamma curve in the next frame.

According to the arrangement, in every frame, a different one of the gamma curves is used for each of the pixels. In addition, in every frame, the first pixel row and the second pixel row are alternately disposed in each of the pixel rows. This produces a viewing angle compensation effect along a temporal axis. This makes it possible to improve visibility in the oblique view state and display a smooth video image. In addition, it is possible to prevent deterioration in resolution feeling.

Further, the display apparatus of the present invention is preferably arranged such that: in driving each of the plurality of pixels, in a case where the drive circuit uses the first gamma curve or the second gamma curve in a certain frame, the drive circuit uses the third gamma curve in a next frame; in a case where the drive circuit uses the third gamma curve in the certain frame, and uses the first gamma curve in a previous frame, the drive circuit uses the second gamma curve in the next frame; and in a case where the drive circuit uses the third gamma curve in the certain frame and uses the second gamma in the previous frame, the drive circuit uses the first gamma curve in the next frame.

According to the arrangement, in every frame, a different one of the gamma curves is used for each of the pixels. In addition, in every frame, the first pixel row and the second pixel row are alternately disposed in each of the pixel rows. This produces a viewing angle compensation effect along a temporal axis. This makes it possible to further improve visibility in the oblique view state in both the vertical direction and the horizontal direction of the display panel, and display a smooth video image. In addition, deterioration in resolution feeling can be prevented.

Further, the display apparatus of the present invention is preferably arranged such that: the drive circuit drives the display panel at a frame frequency higher than a frame frequency at which an image signal is supplied to the display apparatus.

The arrangement makes it possible to suppress a flicker. In addition, deterioration in resolution feeling can be reduced.

Further, the display apparatus of the present invention is preferably arranged such that: the drive circuit drives the display panel at a frame frequency which is three times ±10% higher than a frame frequency at which an image signal is supplied to the display apparatus.

The arrangement makes it possible to prevent deterioration in resolution feeling.

Further, the display apparatus of the present invention is preferably arranged such that: the drive circuit drives the display panel at a frame frequency which is two times ±10% higher than a frame frequency at which an image signal is supplied to the display apparatus.

The arrangement makes it possible to prevent deterioration in resolution feeling.

Further, the display apparatus of the present invention preferably includes: an input interface compliant with an NTSC standard, the drive circuit driving the display panel at a frame frequency higher than 60 Hz in a case where an image signal is supplied via the input interface.

The arrangement makes it possible to suppress a flicker, and also reduce deterioration in resolution feeling.

Further, the display apparatus of the present invention preferably includes: an input interface compliant with an NTSC standard, the drive circuit driving the display panel at a frame frequency of 180 Hz±10% in a case where an image signal is supplied via the input interface.

The arrangement makes it possible to prevent deterioration in resolution feeling.

Further, the display apparatus of the present invention preferably includes: an input interface compliant with an NTSC standard, the drive circuit driving the display panel at a frame frequency of 120 Hz±10% in a case where an image signal is supplied via the input interface.

The arrangement makes it possible to prevent deterioration in resolution feeling.

Further, the display apparatus of the present invention preferably includes: an input interface compliant with a PAL standard, the drive circuit driving the display panel at a frame frequency higher than 50 Hz in a case where an image signal is supplied via the input interface.

The arrangement makes it possible to suppress a flicker, and also reduce deterioration in resolution feeling.

Further, the display apparatus of the present invention preferably includes: an input interface compliant with a PAL standard, the drive circuit driving the display panel at a frame frequency of 150 Hz±10% in a case where an image signal is supplied via the input interface.

The arrangement makes it possible to prevent deterioration in resolution feeling.

Further, the display apparatus of the present invention preferably includes: an input interface compliant with a PAL standard, the drive circuit driving the display panel at a frame frequency of 100 Hz±10% in a case where an image signal is supplied via the input interface.

The arrangement makes it possible to prevent deterioration in resolution feeling.

Further, the display apparatus of the present invention is preferably arranged such that: a density of the plurality of pixels in the display panel is not lower than 140 ppi.

According to the arrangement, a viewer less likely to undergo deterioration in resolution feeling. This makes it possible to improve display performance more effectively, by expanding a viewing angle.

Further, the display apparatus of the present invention is preferably arranged such that: the number of the plurality of pixels in the display panel is not less than 230,000.

According to the arrangement, a viewer less likely to undergo deterioration in resolution feeling. This makes it possible to improve display performance more effectively, by expanding a viewing angle.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

The present invention makes it possible to expand a viewing angle. Therefore, the present invention is widely applicable to devices for displaying images (e.g., liquid crystal display apparatuses).

### REFERENCE SIGNS LIST

1 Display panel
2 Gate driver (drive circuit)
3 Source driver (drive circuit)
10 Pixel
10A Pixel (pixel of first primary color)
10B Pixel (pixel of second primary color)
10C Pixel (pixel of third primary color)
11A Pixel (first pixel)
11B Pixel (second pixel)
11C Pixel (third pixel)
20 Pixel set
21 Pixel row (first pixel row)
22 Pixel row (second pixel row)
100 Display apparatus
γ0 Target gamma characteristic
γ1 Gamma characteristic (first gamma characteristic)
γ2 Gamma characteristic (second gamma characteristic)
γ3 Gamma characteristic (third gamma characteristic)
C0 Target gamma curve
C1 Gamma curve (first gamma curve)
C2 Gamma curve (second gamma curve)
C3 Gamma curve (third gamma curve)
R Red (first primary color)
G Green (second primary color)
B Blue (third primary color)
Fn, Fn+1, Fn+2, Fn+3, Fn+4 Frame

1. A display apparatus comprising:
a display panel including a plurality of pixels disposed in a deltaic pattern; and
a drive circuit for driving the plurality of pixels,
the plurality of pixels being divided into a first pixel group, a second pixel group, and a third pixel group which are disposed in respective different positions,
said drive circuit driving the first pixel group by using a first gamma curve which indicates a first gamma characteristic,
said drive circuit driving the second pixel group by using a second gamma curve which indicates a second gamma characteristic which is different from the first gamma characteristic, and
said drive circuit driving the third pixel group by using a third gamma curve which indicates a third gamma characteristic which is different from each of the first gamma characteristic and the second gamma characteristic.

2. The display apparatus as set forth in claim 1,
wherein:
a relative luminance corresponding to a gradation on the first gamma curve is higher than a relative luminance corresponding to the gradation on a target gamma curve which indicates a target gamma characteristic; and
a relative luminance corresponding to a gradation on the second gamma curve is lower than a relative luminance corresponding to the gradation on the target gamma curve.

3. The display apparatus as set forth in claim 2,
wherein:
a relative luminance corresponding to a gradation on the third gamma curve is higher than a relative luminance corresponding to the gradation on the target gamma curve.

4. The display apparatus as set forth in claim 2,
wherein:
a relative luminance corresponding to a gradation on the third gamma curve is lower than a relative luminance corresponding to the gradation on the target gamma curve.

5. The display apparatus as set forth in claim 2,
wherein:
the third gamma curve intersects with the target gamma curve at a certain gradation;
a relative luminance corresponding to a first gradation which is any gradation on the third gamma curve lower than the certain gradation is lower than a relative luminance corresponding to the first gradation on the target gamma curve; and
a relative luminance corresponding to a second gradation which is any gradation on the third gamma curve higher than the certain gradation is higher than a relative luminance corresponding to the second gradation on the target gamma curve.

6. The display apparatus as set forth in claim 2,
wherein:
the third gamma curve intersects with the target gamma curve at a certain gradation;
a relative luminance corresponding to a first gradation which is any gradation on the third gamma curve higher than the certain gradation is lower than a relative luminance corresponding to the first gradation on the target gamma curve; and
a relative luminance corresponding to a second gradation which is any gradation on the third gamma curve lower than the certain gradation is higher than a relative luminance corresponding to the second gradation on the target gamma curve.

7. The display apparatus as set forth in claim 2,
wherein:
an average of (i) a relative luminance corresponding to a gradation on the first gamma curve, (ii) a relative luminance corresponding to the gradation on the second gamma curve, and (iii) a relative luminance corresponding to the gradation on the third gamma curve is equal to a relative luminance corresponding to the gradation on the target gamma curve.

8. The display apparatus as set forth in claim 2, wherein:
the third gamma curve is identical with the target gamma curve.)

9. The display apparatus as set forth in claim 2,
wherein:
the first gamma curve intersects with the target gamma curve at a first certain gradation;
a relative luminance corresponding to a third gradation which is any gradation on the first gamma curve lower than the first certain gradation is higher than a relative luminance corresponding to the third gradation on the target gamma curve;
a relative luminance corresponding to a fourth gradation which is any gradation on the first gamma curve higher than the first certain gradation is lower than a relative luminance corresponding to the fourth gradation on the target gamma curve;
the second gamma curve intersects with the target gamma curve at a second certain gradation;
a relative luminance corresponding to a fifth gradation which is any gradation on the second gamma curve lower than the second certain gradation is lower than a relative luminance corresponding to the fifth gradation on the target gamma curve;
a relative luminance corresponding to a sixth gradation which is any gradation on the second gamma curve higher than the second certain gradation is higher than a relative luminance corresponding to the sixth gradation on the target gamma curve; and
the third gamma curve is identical with the target gamma curve.

10. The display apparatus as set forth in claim 9,
wherein:
the first certain gradation and the second certain gradation are equal to each other.

11. The display apparatus as set forth claim 8, wherein:
the target gamma characteristic is not less than 1.7 but no more than 2.7.

12. The display apparatus as set forth claim 8,
wherein:
the target gamma curve is a curve having one inflection point.

13. The display apparatus as set forth in claim 8,
wherein:
an average of (i) a relative luminance corresponding to a gradation on the first gamma curve and (ii) a relative luminance corresponding to the gradation on the second gamma curve is equal to a relative luminance corresponding to the gradation on the target gamma curve.

14. The display apparatus as set forth in claim 1,
wherein:
among three pixels which are any three pixels in the plurality of pixels and which are triangularly disposed,
any pixel is a pixel of a first primary color;
another pixel is a pixel of a second primary color which is different from the first primary color; and
another pixel is a pixel of a third primary color which is different from each of the first primary color and the second primary color.

15. The display apparatus as set forth in claim 14,
wherein:
a pixel group made up of a pixel of the first primary color, a pixel of the second primary color, and a pixel of the third primary color, which are successively disposed in a row direction of the display panel, corresponds to one pixel set;
all pixels contained in any one of any three pixel sets which are triangularly disposed in the display panel constitute the first pixel group;
all pixels contained in another one of the any three pixel sets constitute the second pixel group; and
all pixels contained in another one of the any three pixel sets constitute the third pixel group.

16. The display apparatus as set forth in claim 14,
wherein:
the first pixel group is made up of pixels of the first primary color;
the second pixel group is made up of pixels of the second primary color; and
the third pixel group is made up of pixels of the first primary color.

17. The display apparatus as set forth in claim 14,
wherein:
a pixel group made up of a pixel of the first primary color, a pixel of the second primary color, and a pixel of the third primary color, which are successively disposed in a row direction of the display panel, corresponds to one pixel set;
a pixel of the first primary color which pixel is contained in any one of any three pixel sets which are triangularly disposed in the display panel constitutes the first pixel group;
a pixel of the first primary color which pixel is contained in another one of the any three pixel sets constitutes the second pixel group;
a pixel of the first primary color which pixel is contained in another one of the any three pixel sets constitutes the third pixel group; and
in driving the pixels of the second primary color and the pixel of the third primary color, the drive circuit uses the target gamma curve which indicates the target gamma characteristic.

18. The display apparatus as set forth in claim 14, w
herein:
a pixel group made up of a pixel of the first primary color, a pixel of the second primary color, and a pixel of the third primary color, which are successively disposed in a row direction of the display panel, corresponds to one pixel set;
a pixel of the first primary color and a pixel of the second primary color which are contained in any one of any three pixel sets which are triangularly disposed in the display panel constitutes the first pixel group;
a pixel of the first primary color and a pixel of the second primary color which are contained in another one of the any three pixel sets constitutes the second pixel group;
a pixel of the first primary color and a pixel of the second primary color which are contained in another one of the any three pixel sets constitutes the third pixel group; and
in driving the pixels of the third primary color, the drive circuit uses the target gamma curve which indicates the target gamma characteristic.

19. The display apparatus as set forth in claim 14, w
herein:
a pixel group made up of a pixel of the first primary color, a pixel of the second primary color, and a pixel of the third primary color, which are successively disposed in a row direction of the display panel, corresponds to one pixel set;
among three pixels which are contained in any one of any three pixel sets which are triangularly disposed in the display panel, a pixel of the first primary color and a pixel of the second primary color constitute the first pixel group, and a pixel of the third primary color constitutes the third pixel group;
among three pixels which are contained in another one of the any three pixel sets, a pixel of the first primary color and a pixel of the second primary color constitute the second pixel group, and a pixel of the third primary color constitutes the first pixel group; and
among three pixels which are contained in another one of the any three pixel sets, a pixel of the first primary color and a pixel of the second primary color constitute the third pixel group, and a pixel of the third primary color constitutes the second pixel group.

20. The display apparatus as set forth in claim 1,
wherein:
among three pixels which are any three pixels in the plurality of pixels and which are triangularly disposed,
any pixel constitutes the first pixel group;
another pixel constitutes the second pixel group; and
another pixel constitutes the third pixel group.

21. The display apparatus as set forth in claim 8, wherein:
first pixel rows and second pixel rows are alternately disposed in the display panel;
first pixels constituting the first pixel group and second pixels constituting the second pixel group are alternately disposed in each of the first pixel rows; and
only third pixels constituting the third pixel group are disposed in each of the second pixel rows.

22. The display apparatus as set forth in claim 21,
wherein:
in a first pixel row which is followed by any second pixel row, a first pixel is disposed in a certain line and a second pixel is disposed in a line next to the certain line; and
in a first pixel row which follows the any second pixel row, a first pixel is disposed in the certain line and a second pixel is disposed in the line next to the certain line.

23. The display apparatus as set forth in claim 21,
wherein:
in a first pixel row which is followed by any second pixel row, a first pixel is disposed in a certain line and a second pixel is disposed in a line next to the certain line; and
in a first pixel row which follows the any second pixel row, a second pixel is disposed in the certain line and a first pixel is disposed in the line next to the certain line.

24. The display apparatus as set forth in claim 20,
wherein:
in driving each of the plurality of pixels,
in a case where the drive circuit uses the first gamma curve in a certain frame, the drive circuit uses the second gamma curve in a next frame;
in a case where the drive circuit uses the second gamma curve in the certain frame, the drive circuit uses the third gamma curve in the next frame; and
in a case where the drive circuit uses the third gamma curve in the certain frame, the drive circuit uses the first gamma curve in the next frame.

25. The display apparatus as set forth in claim 20,
wherein:
in driving each of the plurality of pixels,
in a case where the drive circuit uses the first gamma curve in a certain frame, the drive circuit uses the third gamma curve in a next frame;
in a case where the drive circuit uses the second gamma curve in the certain frame, the drive circuit uses the first gamma curve in the next frame; and
in a case where the drive circuit uses the third gamma curve in the certain frame, the drive circuit uses the second gamma curve in the next frame.

26. The display apparatus as set forth claim 20,
wherein:
in driving each of the plurality of pixels,
in a case where the drive circuit uses the first gamma curve in a certain frame, the drive circuit uses the second gamma curve in a next frame;
in a case where the drive circuit uses the second gamma curve in the certain frame, the drive circuit uses the first gamma curve in the next frame; and
in a case where the drive circuit uses the third gamma curve in the certain frame, the drive circuit uses the third gamma curve in the next frame.

27. The display apparatus as set forth in claim 22,
wherein:
in driving each of the plurality of pixels, in a case where the drive circuit uses the first gamma curve or the second gamma curve in a certain frame, the drive circuit uses the third gamma curve in a next frame;
in a case where the drive circuit uses the third gamma curve in the certain frame, and uses the first gamma curve in a previous frame, the drive circuit uses the first gamma curve in the next frame; and
in a case where the drive circuit uses the third gamma curve in the certain frame and uses the second gamma in the previous frame, the drive circuit uses the second gamma curve in the next frame.

28. The display apparatus as set forth in claim 22,
wherein:
in driving each of the plurality of pixels,
in a case where the drive circuit uses the first gamma curve or the second gamma curve in a certain frame, the drive circuit uses the third gamma curve in a next frame;
in a case where the drive circuit uses the third gamma curve in the certain frame, and uses the first gamma curve in a previous frame, the drive circuit uses the second gamma curve in the next frame; and
in a case where the drive circuit uses the third gamma curve in the certain frame and uses the second gamma in the previous frame, the drive circuit uses the first gamma curve in the next frame.

29. The display apparatus as set forth in claim 24, wherein:
the drive circuit drives the display panel at a frame frequency higher than a frame frequency at which an image signal is supplied to the display apparatus.

30. The display apparatus as set forth in claim 24, wherein:
the drive circuit drives the display panel at a frame frequency which is three times ±10% higher than a frame frequency at which an image signal is supplied to the display apparatus.

31. The display apparatus as set forth in claim 24, wherein:
the drive circuit drives the display panel at a frame frequency which is two times ±10% higher than a frame frequency at which an image signal is supplied to the display apparatus.

32. The display apparatus as set forth in claim 24, further comprising:
an input interface compliant with an NTSC standard,
the drive circuit driving the display panel at a frame frequency higher than 60 Hz in a case where an image signal is supplied via the input interface.

33. The display apparatus as set forth in claim 24, further comprising:
an input interface compliant with an NTSC standard,
the drive circuit driving the display panel at a frame frequency of 180 Hz±10% in a case where an image signal is supplied via the input interface.

34. The display apparatus as set forth in, claim 26 further comprising:
an input interface compliant with an NTSC standard,
the drive circuit driving the display panel at a frame frequency of 120 Hz±10% in a case where an image signal is supplied via the input interface.

35. The display apparatus as set forth in claim 24, further comprising:
an input interface compliant with a PAL standard,
the drive circuit driving the display panel at a frame frequency higher than 50 Hz in a case where an image signal is supplied via the input interface.

36. The display apparatus as set forth in claim 24, further comprising:
an input interface compliant with a PAL standard,
the drive circuit driving the display panel at a frame frequency of 150 Hz±10% in a case where an image signal is supplied via the input interface.

37. The display apparatus as set forth in claim 26, further comprising:
an input inter face compliant with a PAL standard,
the drive circuit driving the display panel at a frame frequency of 100 Hz±10% in a case where an image signal is supplied via the input interface.

38. The display apparatus as set forth claim 1, wherein:
a density of the plurality of pixels in the display panel is not lower than 140 ppi.

39. The display apparatus as set forth in claim 1, wherein:
the number of the plurality of pixels in the display panel is not less than 230,000.
